(19) United States
(12) Patent Application Publication
(10) Pub. No.: US 2023/0396111 A1
(43) Pub. Date: Dec. 7, 2023

(54) SYSTEM AND METHOD FOR THERMAL MANAGEMENT OF ELECTRONIC MACHINES USING COOLANT CANS

(71) Applicant: Tau Motors, Inc., Redwood City, CA (US)

(72) Inventors: Walter Wesley Pennington, III, Menlo Park, CA (US); Ethan Bagget Swint, Redwood City, CA (US); Gregory Gordon Stevenson, San Carlos, CA (US); Michael Parker Owen, Raleigh, NC (US); Matthew Joseph Reeve, San Jose, CA (US); Matthew J. Rubin, Indianapolis, IN (US)

(21) Appl. No.: 18/033,775

(22) PCT Filed: Oct. 27, 2021
(86) PCT No.: PCT/US21/56917

§ 371 Date: Apr. 25, 2023

Related U.S. Application Data
(60) Provisional application No. 63/106,096, filed on Oct. 27, 2020.

(51) Int. Cl. H02K 3/24; H02K 11/25; H02K 1/32; H02K 1/20

(52) U.S. Cl. CPC H02K 3/24; H02K 11/25; H02K 1/32; H02K 1/20

(57) ABSTRACT

An electric machine having a thermal management system includes a stator having a stator core, and a rotor having a rotor core that is moveable relative to the stator. At least one of the stator and the rotor include one or more windings. One or more coolant cans encapsulate one or more of the windings disposed on the at least one of the stator and the rotor in an interior compartment of the coolant can. The interior compartment of the coolant can defines a coolant flow passage through the one or more windings. The coolant can includes a coolant inlet and a coolant outlet in fluid connection with the interior compartment of the coolant can. The interior compartment of the one or more coolant cans are fluidically isolated from the stator core and the rotor core.

### CROSS-REFERENCE TO RELATED APPLICATIONS

This application claims priority to U.S. Provisional Application No. 63/106,096, titled “Motors Including Coolant Cans,” filed on Oct. 27, 2020, which is hereby incorporated by reference in its entirety.

### BACKGROUND

During the operation of an electric machine, some electrical components of the machine may increase in temperature. In some electric machines, it may be undesirable for some electrical components of the machine to increase in temperature during operation and, at the same time, it may be desirable for some other electrical components of the machine to increase in temperature during operation. In conventional electric machine thermal management systems, coolant fluid is commonly utilized to provide cooling to components of an electric machine, or to the electric machine in its entirety. In such systems, directed cooling to particular components of the electric machine may be difficult because of the dynamic operation of some electric machines.

For example, in some electric machines, such as electric motors or generators, the machine includes a stationary component, often referred to as a stator, and a rotational component, often referred to as a rotor. In electric motors, electric current is translated into electromagnetic fields that exert a mechanical force, or torque, between the stator and the rotor, which may be used to do work. Generators work on similar principles as electric motors but with mechanical force being translated into electric current. While primarily described in terms of rotational force, or torque, the principles described herein are also applicable to linear motors. For example, in some linear motors, the rotor serves as the stationary component while the stator serves as a translated component.

Particularly in electrical motors, windings of electrical wire or conductive elements disposed on and/or in the stator and/or rotor of the motor increase in temperature during continued operation of the machine. Thermal management of these windings or conductive elements is particularly important in electric motors because as the temperature of the windings or conductive elements increases, the output performance of the electric motor decreases. As such, liquid coolant is often flowed through the motor during operation to provide cooling to the windings or conductive elements disposed on and/or within the stator and/or rotor of the machine. Unfortunately, these conventional thermal management systems and methods of electric machines may generate inefficiencies and additional losses of performance to other components of the electric machine. Therefore, an improved thermal management system and method of electric machines are necessary for the improvement of the performance of electric machines and motor assemblies.

### SUMMARY OF THE DISCLOSURE

The present disclosure provides systems and methods of thermal management of electric machines using coolant cans.

In some aspects of the disclosure, an electric machine having a thermal management system includes a stator having a stator core and a rotor having a rotor core that is movable with respect to the stator. One or more windings are included in at least one of the stator or the rotor of the electric machine. One or more coolant cans encapsulate the one or more windings of the at least one of the stator or the rotor in an interior compartment of the coolant can that defines a coolant flow passage through the one or more windings. The coolant can includes a coolant inlet and a coolant outlet in fluid connection with the interior compartment of the coolant can that is fluidically isolated from the stator core and the rotor core.

In another aspect of the disclosure, an electric machine having a thermal management system includes a stator having a stator core, a rotor having a rotor core that is movable with respect to the stator, a coolant pump, and a controller in electrical connection with the coolant pump that is configured to control the coolant pump. One or more windings are included in at least one of the stator or the rotor of the electric machine. One or more coolant cans encapsulate one or more of the windings disposed on or within the at least one of the stator or the rotor in an interior compartment of the coolant can that defines a coolant flow passage through the one or more windings. The coolant can includes a coolant inlet and a coolant outlet in fluid connection with the interior compartment, and the coolant pump is in fluid communication with one or more coolant inlets of the one or more coolant cans.

In still another aspect of the disclosure, a method for thermal management of an electric machine having a thermal management system includes flowing a coolant through an interior compartment of one or more coolant cans that encapsulate one or more windings of the electric machine within the interior compartment of the coolant can. The interior compartment of the coolant can being fluidically isolated from other components of the electric machine.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTIONS OF THE DRAWINGS

FIG. 1 is a block diagram of an example electric drive system including an electric motor;

FIG. 2 is a front isometric view of an example stator of an electric motor according to the present disclosure;

FIG. 3 is a rear isometric view of the stator of FIG. 2;

FIG. 4 is a front view of the stator of FIG. 2;

FIG. 5 is a rear view of the stator of FIG. 2;

FIG. 6 is a side view of the stator of FIG. 2;

FIG. 7 is a perspective view of an example winding of the stator of FIG. 2;

FIG. 8 is a perspective view of an example coolant can of the stator of FIG. 2 with the winding of FIG. 7 disposed within and a lid of the coolant can in an exploded configuration;

FIG. 9 is a perspective view of the assembled coolant can of FIG. 8 and an example stator tooth of the stator of FIG. 2;

FIG. 10 is a perspective view of the coolant can of FIG. 9 inserted onto a stator tooth with a gap piece inserted;

FIG. 11 is a cross-sectional view taken along line 11-11 of FIG. 10;

FIG. 12 is a partial cross-sectional view taken along line 12-12 of FIG. 2;

FIG. 13 is a front isometric view of another example stator of an electric motor according to the present disclosure;

FIG. 14 is a front view of the stator of FIG. 13;

FIG. 15 is a side view of the stator of FIG. 13;

FIG. 16 is a perspective view of a coolant can frame of a stator core of the stator of FIG. 13;

FIG. 17 is an isometric view of a lamination of a stator core of the stator of FIG. 13;

FIG. 18 is an isometric view of the stator core of FIG. 13

FIG. 19 is a detailed view of detail 19-19 of FIG. 18 with example gap pieces inserted into gaps of the stator core;

FIG. 20 is an isometric view of an example gap piece of FIG. 19;

FIG. 21 is an isometric view of the stator of FIG. 13 with an endcap piece removed;

FIG. 22 is a cross-section view taken along line 22-22 of FIG. 14;

FIG. 23 is a cross-sectional view taken along line 23-23 of FIG. 15;

FIG. 24 is a front isometric view of another example stator of an electric motor according to the present disclosure;

FIG. 25 is a front view of the stator of FIG. 24;

FIG. 26 is a rear view of the stator of FIG. 24;

FIG. 27 is a side view of the stator of FIG. 24;

FIG. 28 is a perspective view an example coolant can of the stator of FIG. 24;

FIG. 29 is an exploded view of the coolant can of FIG. 28;

FIG. 30 is a rear perspective view of the coolant can of FIG. 28 disposed on a stator tooth;

FIG. 31 is a front perspective view the coolant can of FIG. 31;

FIG. 32 is a cross-sectional taken along line 32-32 of FIG. 31;

FIG. 33 is a front isometric view of another example stator of an electric motor according to the present disclosure;

FIG. 34 is a front view of the stator of FIG. 33;

FIG. 35 is a rear view of the stator of FIG. 33;

FIG. 36 is a side view of the stator of FIG. 33;

FIG. 37 is a rear perspective view of an example coolant can of the stator of FIG. 33;

FIG. 38 is an exploded view of the coolant can of FIG. 37;

FIG. 39 is a rear perspective view of the coolant can of FIG. 37 disposed on a stator tooth;

FIG. 40 is a front perspective view of the coolant can of FIG. 39;

FIG. 41 is a cross-sectional view taken along line 41-41 of FIG. 40;

FIG. 42 is a front isometric view of an example rotor of an electric motor according to the present disclosure;

FIG. 43 is a side view of the rotor of FIG. 42;

FIG. 44 is a front view of the rotor of FIG. 42;

FIG. 45 is a rear view of the rotor of FIG. 42;

FIG. 46 is an exploded view of the rotor of FIG. 42;

FIG. 47 is an exploded view of a coolant can of the rotor of FIG. 42;

FIG. 48 is an exploded view of a coolant can and a rotor pole of the rotor of FIG. 42;

FIG. 49 is an exploded view of a shaft from the rotor of FIG. 42

FIG. 50 is an exploded view of the endcaps of the rotor of FIG. 42;

FIG. 51 is a cross-sectional view taken along line 51-51 of FIG. 42;

FIG. 52 is a cross-sectional view taken along line 52-52 of FIG. 42;

FIG. 53 is a cross-sectional view taken along line 53-53 of FIG. 42;

FIG. 54 is a cross-sectional view taken along line 51-51 of FIG. 42 with another example shaft of the rotor according to the present disclosure;

FIG. 55 is a perspective view of an example winding having an electrical component of an electric motor according to the present disclosure;

FIG. 56 is detailed view of an example internal surface of a coolant can according to the present disclosure;

FIG. 57 is a schematic illustration of an example temperature control module for an electric machine; and

FIG. 58 is a schematic illustration of various components of example coolant flow system including a coolant manifold of an electric machine.

### DETAILED DESCRIPTION

As detailed above, some electric machines may require a thermal management system, including cooling and thermal management systems, during operation in order to maintain performance and increase the lifecycle of the machine. This disclosure relates to a thermal management system of an electric machine, for example, an electric motor with an electromagnetically coupled rotor and stator. In an electric motor, either or both of the stator and the rotor include windings of electrical wire or conductive elements that allow for electromagnetic coupling by currents travelling through the windings. These currents cause heat to dissipate in the windings, with potentially negative effects to the performance and lifespan of the electric motor. For example, the conductors or associated components of the electric motor may be mechanically damaged by high temperatures, or the electrical resistance of the conductors may be increased as the temperature of the windings increases resulting in decreased performance of the electric motors.

Liquid coolant can be used to maintain acceptably low temperatures in windings of electric machines, such as windings of an electric motor. Conventional cooling in electric motors includes, for example, forced air cooling, spray cooling and immersion cooling. Forced air cooling pushes air through the motor assembly to cool windings or conductive elements of the motor. Spray cooling systems can be configured to target specific motor components with jets of coolant. Immersion cooling systems immerse the entire motor assembly in a contained volume of liquid coolant in operation. Of these conventional cooling systems, immersion cooling is the most effective at cooling the windings, however, both of the cooling systems described above result in significant amounts of coolant in the working volume of an electric motor, thus causing either or both of at least two undesirable effects.

First, windage or drag losses are increased when moving components of the motor come in contact with coolant, especially when coolant is present in the air gap (i.e., the gap between the stator and the rotor) of the motor, a common result of immersive cooling. Spray cooling may reduce this negative effect but with decreased cooling effectiveness compared to immersive cooling. Additionally, spray cooling typically involves significant interaction between other motor components due to both proximity of the stator and the rotor bodies within the working volume of the motor assembly and effects arising from operation. Forced air cooling also suffers from windage or drag losses, especially at higher air flows that are required for advanced cooling capability or power dense machine designs.

Second, as described above, in conventional electric motor designs, it is beneficial to maintain windings at a lower temperature than their corresponding stator core or rotor core. Immersive cooling, including significant coolant in the working volume of the motor, applies cooling indiscriminately to the windings, the stator core, and the rotor core, such that, as the windings are cooled, the stator core and rotor core are cooled as well. Likewise, spray cooling can result in unintentional cooling of the stator core and the rotor core as the sprayed coolant flows from the windings and disperses in the working volume of the motor, including on the stator core and the rotor core.

In addition, whereas many conductive elements, such as copper in a non-limiting example, are most efficient when regulated at the lowest possible temperature as the resistivity of the winding conductors is proportional to the operating temperature, other materials used in a motor, such as steel laminations in a non-limiting example, may benefit from higher operating temperatures wherein their losses can be minimized under such conditions, for instance. Thus, the direct cooling of some bodies in an electric machine is not always beneficial or desirable, presenting conflicting requirements within a given machine. Other components such as magnets, semiconductors, or even simply the stator or the rotor may demand different thermal capabilities and operating conditions relative to each other, further compounding the thermal management needs of an electric machine.

Furthermore, many traditional electric motor and motor assembly designs utilize passive or active heat jackets that function to remove heat from the conductive elements through the machine core, magnetic elements, or housings of the machine. That is, the thermal flow of the electric machine and the machine assembly is designed to operate through the magnetic components that produce a thermal gradient in which the conductors are a higher temperature than the core. This, in some instances, is detrimental to the performance of the core and/or machine itself as described above.

Recognizing these drawbacks, and in an effort to increase performance of electric machines having windings or conductive elements, the present disclosure provides systems and methods of a thermal management system that provide cooling to windings or conductive elements in isolation from the working volume, including other internal components, of the electric machine. For example, the electric machines described in the present disclosure include coolant cans that encapsulate windings or conductive elements, such that coolant flows through the coolant cans and contacts only the windings or conductive elements of a stator, a rotor, or both. In operation, the coolant cans effectively provide the efficiency benefits of immersive cooling but only to the windings or conductive elements. The coolant cans fluidically isolate the coolant from other internal components of the electric machine, for example, the stator core or the rotor core of an electric motor on which the windings or conductive elements are mounted or electrically in communication with, such that a relatively high temperature can be maintained in the stator core or the rotor core in relation to the encapsulated windings or conductive elements. In some cases, the present disclosure enables the stator core and/or the rotor core to be maintained at a higher temperature than the windings or conductive elements disposed therein during motor operation, representing a significant break with conventional internal motor processes.

As described above, in an electric motor, fluidic isolation of coolant in the windings or conductive elements to the stator core or rotor core can result in improved motor performance. Unlike motor windings, which typically decrease in efficiency as their temperature rises (e.g., because of increasing resistance), stator cores and rotor cores often exhibit increased efficiency with increasing temperature, because induced eddy currents in the stator cores and rotor cores are correspondingly decreased with increasing temperature. Induced eddy currents act to heat the stator cores and rotor cores independently of any heat transferred from the windings. The inclusion of coolant cans in the thermal management systems of the present disclosure allows a relatively high temperature to be maintained in the stator core or rotor core, thereby simultaneously increasing winding efficiency and housing/core efficiency. As used herein, the “performance” of an electric machine refers to the power density, the thermal headroom, and/or the efficiency of the electric machine.

As will be described herein, the present disclosure provides systems and methods for a thermal management system of an electric machine using coolant cans that are configured to provide directed cooling to windings or conductive elements of an electric machine. In one non-limiting example, an electric motor includes coolant cans that encapsulate windings or conductive elements disposed on or within the stator of the motor. Additionally or alternatively, an electric motor or electric motor assembly includes coolant cans that encapsulate windings or conductive elements disposed on or within the rotor of the motor. Additionally or alternatively, an electric motor or electric motor assembly includes coolant cans that encapsulate windings or conductive elements disposed on or within both the stator and the rotor of the motor. Additionally or alternatively, an electric motor or electric motor assembly includes coolant cans that encapsulate windings or conductive elements that are in electrical communication with either the stator or the rotor, or both. Additionally, systems and methods are provided for monitoring and/or regulating coolant flow within, and temperature of, an electric motor or electric motor assembly having a thermal management system using coolant cans.

Although the discussion below frames the present disclosure to electric machines including a stator and/or a rotor, the disclosure is not intended to be limited to such electric machines. In some implementations, the thermal management systems and methods, including the coolant cans, may be applied to other electric machines having windings or conductive elements, for example, an electrical transformer and an electrical inverter. In various implementations, the thermal management systems and methods may be applied to generators, coupled electric (or electromagnetic) systems, and mechanical and/or electrical power conversion devices that alter the mechanical or electric pressure and flow of energy from one input to a desired output.

In some implementations, the thermal management systems and methods, including the coolant cans, described below may be applied to provide coolant or thermal regulation to electrical components or environments other than windings or conductive elements of an electrical machines. For example, in some implementations, a transformer of an electrical machine can be encapsulated within one or more coolant cans according to the present disclosure. In some implementations, an inverter of an electrical machine or system can be encapsulated within one or more coolant cans according to the present disclosure.

For the purposes of this disclosure, windings and conductors/conductive elements may be used interchangeably throughout. Conductive elements may include bars, printed circuit boards (PCBs), semiconductors, litz wire, multi-turn coils, cast or solid conductors, carbon nanotubes, or any other element that can conduct electricity in an electrical circuit.

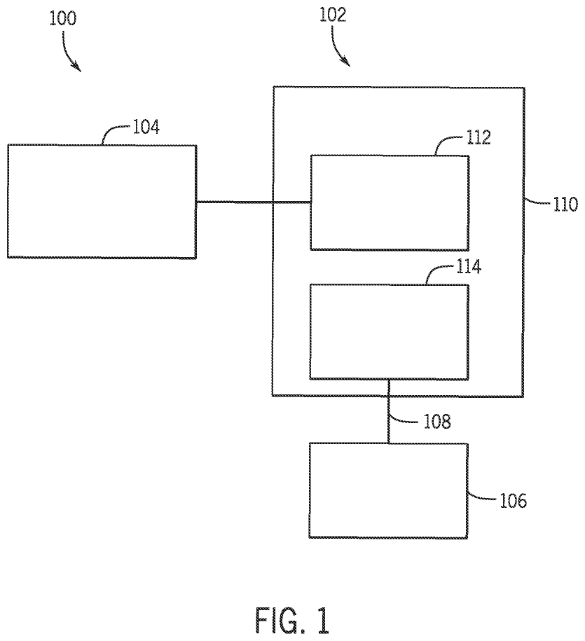

FIG. 1 schematically illustrates an electric drive system 100 that includes an electric motor 102 and a motor controller 104 coupled to the electric motor 102. The motor controller 104 is configured to operate the electric motor 102 to drive a load 106. The load 106 can be an additional gear train such as a gear set, a vehicle wheel, a pump, a compressor, or another motor where multiple motors can be linked and operated in parallel.

The electric motor 102 has an output shaft 108 rotatable with respect to a motor housing 110. The motor housing 110 is considered a datum with respect to rotations and other motions of motor components. In use, the output shaft 108 can be coupled to the load 106, and the electric motor 102 can impart rotary power to the load 106 when electrically activated by appropriate electrical power and signals from the motor controller 104. In some implementations, the output shaft 108 extends through the motor 102 and is exposed at both ends, meaning that rotary power can be transmitted at both ends of the motor 102. Motor housing 110 can be symmetric about a rotation axis of output shaft 108, but the motor housing 110 may be of any external shape and can generally include means for securing the motor housing 110 to other structures to prevent rotation of the housing 110 during operation of the motor 102.

The electric motor 102 may include an active magnetic component 112, such as a stator, and a passive magnetic component 114, such as a rotor. In some implementations, for instance when a rotor has conductors or conductive elements being driven by an inverter or controllable power source, the rotor may be active. The stator, rotor, or both, may have an electrical circuit which is controlled to create an electromagnetic field in a position with respect to the opposing component(s) such that a mechanical force is produced between the components. For illustration purposes herein, in the illustrated implementation, a stator is used as a representative example of the active magnetic component 112 and rotor is used as a representative example of the passive magnetic component 114. In other implementations, the active magnetic component 112 and the passive magnetic component 114 may be other components of other electric machines or motors.

The electric motor 102 may also be described as including at least two magnetic components 112, commonly with a stationary component, or stator, and a component which is free to move 114, such as a rotary component, or rotor. The stator, rotor, or both, have an electrical circuit which is controlled to create an electromagnetic field in a position with respect to the opposing component(s) such that a mechanical force is produced between the components. For illustration purposes herein, in the present implementation, a stator is used as a representative example of the fixed magnetic component 112 and rotor is used as a representative example of the moveable magnetic component 114. In other implementations, the fixed magnetic component 112 and the moveable magnetic component 114 may be other components of other electric machines or motors. The rotor 114 is configured to electromagnetically interact with the stator 112 and can be disposed within the stator 112, e.g., in an internal rotor radial-gap motor, or parallel to the stator 112, e.g., in an axial-gap motor or in a linear motor, or outside of the stator 112 in an external rotor radial-gap motor, or some combination thereof. Electrical activity in the stator 112 drives motion of the rotor 114. The rotor 114 is rotationally coupled to the output shaft 108, such that any resultant rotation of the rotor is transmitted to the output shaft 108, causing the output shaft 108 to rotate. The stator 112 is fixed to the electric motor 102 such that during operation the rotor 114 moves about the stator 112 or parallel to the stator 112.

Electrical current flowing through a loop of electric wire or conductive elements results in a magnetomotive force (MMF) and a motor pole through the wound, or encircled, region of the wire or element. In a typical electric motor, such a loop is designed to have a sufficient diameter to carry the desired current load, which in some implementations should be thin enough such that a skin depth of the drive frequency fully penetrates the loop. In some implementations, many turns, or overlapping loops of wire, are used to increase the pole magnetic field strength. This topology may be referred to as a wound field pole. Such a set of overlapping loops is referred to as a coil.

For the purposes of this disclosure, a coil of electrical wire or conductive elements that is configured to act with other coils or conductive elements within an electrical machine, such as on the stator or rotor of an electric motor, are referred to as a “winding.” In practice, windings may take a variety of forms. For example, in some instances, a wire coil is wound together in series such that each turn of the coil has the same magnetic axis. Such coils wound in series or around individual rotor or stator teeth can be referred to as a “concentrated winding.” In some instances, coils can overlap and encompass multiple teeth of either a rotor or a stator. Such overlapping coils can be referred to as an armature or a “distributed winding.” A pole is a magnetic center of this distributed winding, and as such, the pole can move relative to the individual coils within such a distributed winding depending upon the drive current passing through the winding. In some instances, coils can be wrapped from the tooth slot around the yoke or back iron of either a rotor or a stator. Such coils can be referred to as a “toroidal winding.”

In the example electric motor 102 of FIG. 1, the stator 112 defines multiple stator poles with associated electrical windings, and the rotor 114 defines multiple rotor poles. The rotor 114 defines, together with the stator 112, a nominal air gap between the stator and the rotor; for example, in some implementations, the nominal air gap is defined between rotor teeth and stator teeth. The rotor 114 is movable with respect to the stator 112, e.g., rotatable about an axis of rotation or linearly movable in one or more defined directions.

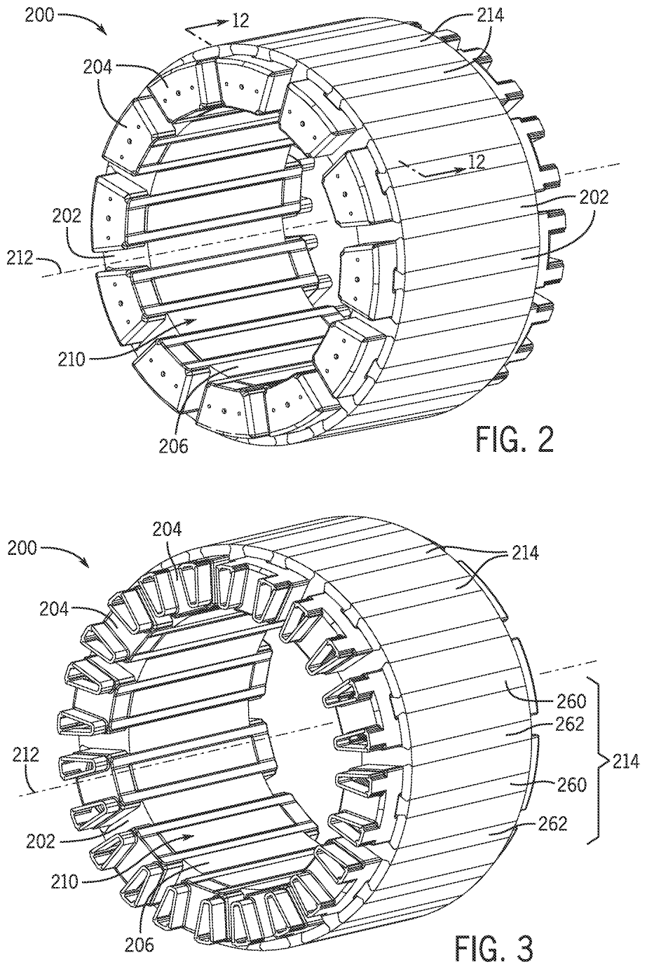

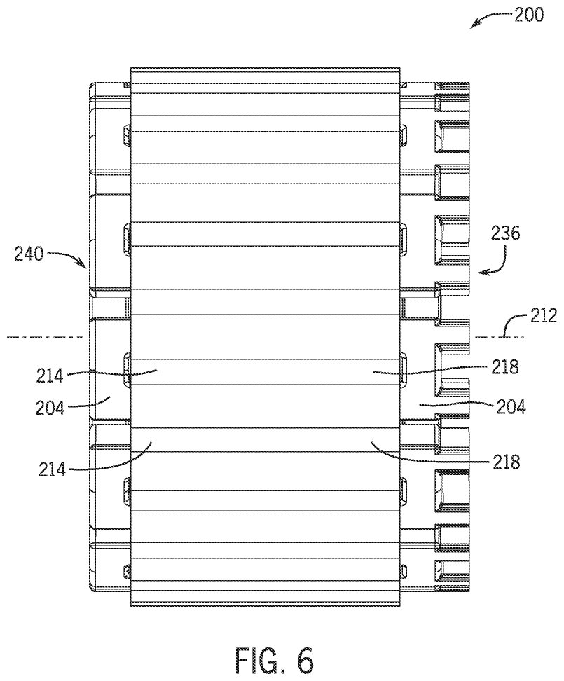

FIGS. 2-6 show a non-limiting example of a stator 200 according to an example implementation of this disclosure. The stator 200 includes a generally cylindrical stator core 202 and a plurality of coolant cans 204 disposed circumferentially around the stator core 202. The stator core 202 has an inner cylindrical surface 206 with an inner diameter 208 that defines an opening 210. The opening 210 is configured to receive a rotor (not shown) of the electric motor such that an air gap exists between the rotor and inner cylindrical surface 206. The stator core 202 has a longitudinal axis 212 extending through the opening 210.

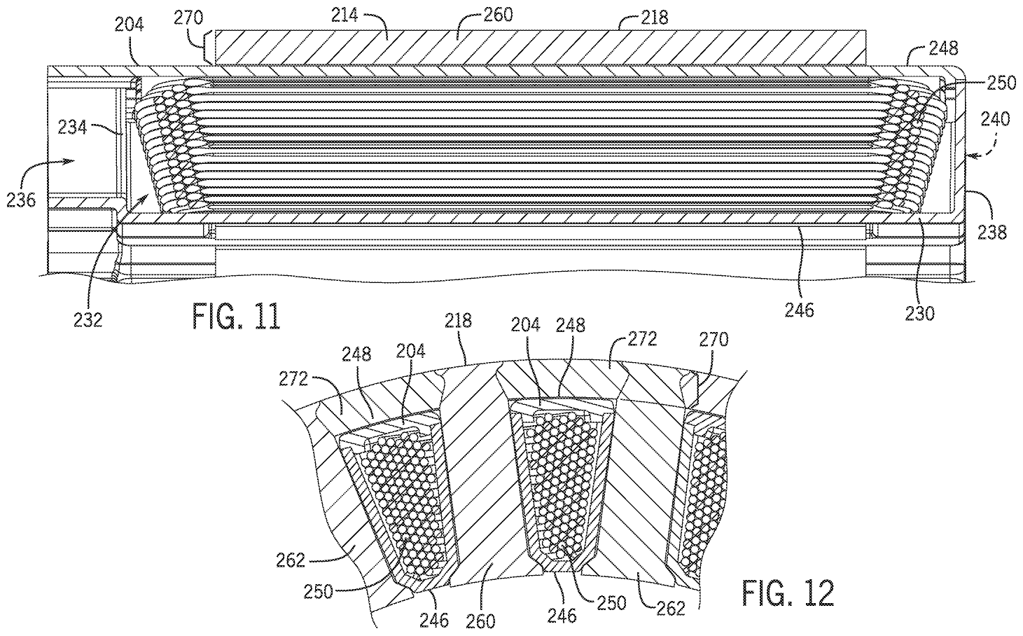

A plurality of stator teeth 214 extend radially from the stator core 202 and are oriented circumferentially around the stator core 202. An outer end 218 of the plurality of stator teeth 214 define an outer diameter 220 of the stator core 202. Each of the plurality of stator teeth 214 are configured to receive an opening of the plurality of coolant cans 204 (see FIGS. 11 and 12). In this implementation, the stator teeth 214 are spaced apart circumferentially such that every other stator tooth 214 receives a coolant can 204 (see FIG. 12)

In some implementations, the stator core 202 (including the stator teeth 214) is comprised of a magnetically permeable material, such as iron. In some implementations, the stator core 202 is comprised of one or more cylinders having stator teeth formed on an outer surface. In some implementations, the stator core 202 is comprised of a plurality of stator plates or laminations that reduce eddy currents within the magnetically permeable material of the stator core 202. For example, in some implementations, stator laminations are included in portions of the stator core 202 that form the outer surface of the stator core 202.

In some implementations, the stator core 202 includes elements in addition to a magnetically permeable material. For example, in some implementations the stator core 202 includes adhesives and/or electrically insulating material (e.g., varnish and/or a metal oxide). In some implementations, portions of the stator core include or are encapsulated in epoxy or another insulating material.

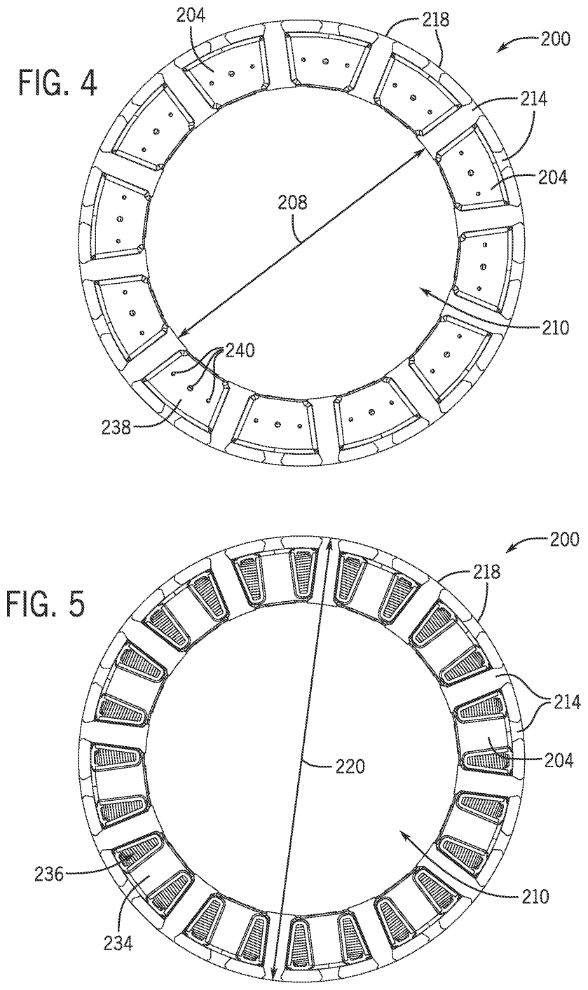

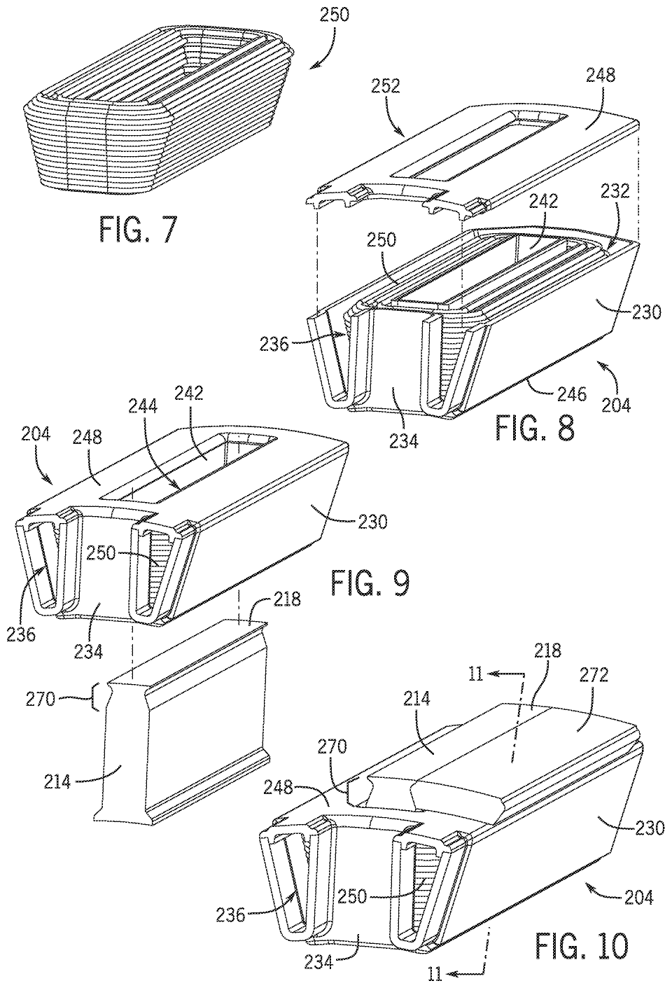

FIGS. 7-12 show the coolant can 204 in greater detail. The coolant can 204 includes a body 230 that defines an interior compartment 232 of the coolant can 204. A rear wall 234 of the body 230 defines one or more inlets 236 that are in fluid communication with the interior compartment 232 of the body 230 of the coolant can 204. A front wall 238 of the body 230 defines one or more outlets 240 (shown in FIGS. 2 and 4) that are in fluid communication with the interior compartment 232 of the body 230 of the coolant can 204. An interior wall 242 of the body 230 is disposed within the interior compartment 232 and defines an opening 244 that extends through a bottom wall 246 and a top wall 248 of the body 230.

Referring to FIG. 8, a concentrated winding 250 is disposed within the interior compartment 232 and around the interior wall 242 of the body 230 (see FIG. 11). In this implementation, the top wall 248 of the body 230 is comprised of a lid 252 removable from the body 230 such that the interior compartment 232 of the body 230 is accessible when the lid 252 is removed. In some implementations, the bottom wall 246 of the body 230 is removable. Once the winding 250 is disposed within the body 230 of the coolant can 204, the lid 252 may be joined to the body 230 by one or more of a variety of methods, including ultrasonic welding, adhesives, and mating clips. These methods of joining portions of the coolant can 204 may also be used to join portions of other example coolant cans described herein. In some implementations, a sealing member, such as a gasket, may be disposed between the lid 252 and the body 230 to provide a fluid seal between the lid 252 and the body 230 of the coolant can 204.

Referring to FIGS. 8-10, the body 230 of the coolant can 204 is configured to encapsulate the winding 250 within the interior compartment 232 of the body 230. In this implementation, the winding 250 is wound in a generally rectangular shape that tapers downward (see FIGS. 7 and 9) such that the winding 250 fits within the interior compartment 232 and around the cylindrical interior wall 242 of the body 230. In some implementations, the winding 250 is wound in a cylindrical shape. In some implementations, the winding 250 is wound to fit around two or more openings 244 of the body 230 of the coolant can 204.

In some implementations, the winding 250 includes elements besides electrical wire. For example, in various implementations, the winding 250 includes an adhesive or binding structure configured to hold together bundles of electrical wire of the winding 250 and/or a potting compound, such as a thermoplastic, configured to fill spaces between individual wires of the winding 250.

In some electrical machines, electrical insulation is required to prevent undesired conduction, or conduction of electrical current that is detrimental to the performance, safety, or lifespan of the system, within the electric machine. For instance, in an electric motor, insulation is required between the conductive elements and the magnetic components (see FIG. 1). Outside of the electrical isolation, this insulator provides no other function in conventional construction of motors and, in certain implementations, impedes or restricts the thermal flow necessary for the cooling of conductive elements. In the present disclosure, the coolant can may provide electrical isolation and thermal management of the system, as described throughout this disclosure. For example, the coolant can may provide electrical isolation in addition to fluidic isolation to direct and control the flow of heat within the system components.

Accordingly, in some implementations, the winding 250 includes one or more layers of insulation that enclose the electrical wires or conductive elements of the winding 250 within the interior compartment 232 of the coolant can 204, such that the winding 250 is electrically insulated from other components of the stator 200, other components of the electrical machine, and/or machines or machine components external to the electrical machine while being cooled by coolant flowing through the coolant can 232. Insulating material may include papers, plastics, varnishes, rubbers, or potting compounds that comprise some or all of the coolant can structure (see FIGS. 11 and 12).

FIG. 11 illustrates a cross-sectional view of a portion of the coolant can 204 taken along line 11-11 in FIG. 10. As seen in FIG. 11, when the coolant can 204 is disposed on the stator tooth 214 of the stator core 202, the stator winding 250 surrounds the stator tooth 214 through the interior wall 242 of the body 230 of the coolant can 204. In the illustrated implementation, each coolant can 204 encapsulates a single winding 250 and surrounds a single stator tooth 214. In other implementations, each coolant can 204 can encapsulate two or more windings 250 and surround two or more stator teeth 214.

The body 230 defines a fluid flow passage through the interior compartment 232 of the coolant can 204, such that when coolant is flowed into the interior compartment 232 of the body 230 via the one or more inlets 236 the coolant flows through gaps of the stator winding 250 (see FIG. 12) and out the interior compartment 232 via the one or more outlets 240 of the body 230. In this implementation, the coolant can 204 is fluidically isolated from the stator core 202, such that flow of coolant through the body 230 of the coolant can 204 contacts the winding 250 but does not contact the stator tooth 214 or the outer surface 216 of the stator core 202.

The cooling efficiency of windings 250 encapsulated in coolant cans 204 may be dependent on the volume of the interior compartment 232 of the coolant can 204 and the volume of the winding 250 disposed within the interior compartment. The more volume that the winding 250 has the less volume of coolant can flow through the interior compartment 232. In some implementations, a ratio between a volume of an interior compartment of a coolant can and a volume of one or more windings disposed therein is between 100:95 to 100:75. In some implementations, the ratio between the volume of the interior compartment of the coolant can and the volume of the one or more windings disposed therein is between 10:9 to 10:7. In some implementations, the ratio between the volume of the interior compartment of the coolant can and the volume of the one or more windings disposed therein is between 5:4 to 2:1. In some implementations, the ratio between the volume of the interior compartment of the coolant can and the volume of the winding is between 5:3 to 10:3.

In some implementations, the effectiveness of cooling the conductive elements may be described by the fluidic thickness established within the coolant can. While traditional thought would prescribe high amounts of fluid relative to conductors in order to adequately submerge and/or reject the requisite heat in operation, greater performance can be achieved by a thinner fluid thickness, or decreased fluidic volume with respect to conductor volume. In some implementations, the fluidic thickness within the interior compartment 232 of the coolant can 204 is in a range of about 0.2 mm to 0.7 mm. In some implementations, the fluidic thickness within the interior compartment 232 of the coolant can 204 is in a range of about 0.5 mm to 1.5 mm. In some implementations, the fluidic thickness within the interior compartment 232 of the coolant can 204 is in a range of about 1 mm to 3 mm. Interestingly, the clearance to minimize the peak coil temperature may not be the same as the clearance necessary to minimize Joule heating losses, which may benefit from the smallest possible clearance. In some applications, reducing peak temperature may be preferred (for instance, high power density applications). In other applications, reducing Joule heating losses may be preferred (for instance, highly efficient applications).

In some implementations, the interior compartment 232 of the coolant can 204 is not fully sealed from other components of the electric motor. For example, in some implementations, portions of two or more coolant cans 204 are in fluid connection with one another and form a partial seal between the interior compartments 232 of the two or more coolant cans 204. In some implementations, the coolant cans 204 may include openings defined in the body 230 of the coolant can in addition to the one or more inlets and outlets 236, 240, such that coolant may flow out of the coolant can 204 and contact other components of the electric motor. For example, one or more holes may be defined in the bottom wall 246 of the body 230 of the coolant can 204 such that when coolant flows through the interior compartment of 232 a volume of coolant may leak out through the one or more holes and come into contact with the stator core 202 or the rotor of the electric motor.

For example, in some implementations, less than 5% of the total volume of coolant that flows into the interior compartment 232 may leak out of the coolant can 204 through paths other than the one or more outlets 240 of the coolant can 204. In some implementations, less than 3% of the total volume of coolant that flows into the interior compartment 232 may leak out of the coolant can 204 through paths other than the one or more outlets 240 of the coolant can 204. In some implementations, less than 1% of the total volume of coolant that flows the interior compartment 232 may leak out of the coolant can 204 through paths other than the one or more outlets 240 of the coolant can 204.

For purposes of this disclosure, in some implementations wherein the coolant cans are configured to facilitate when small amounts of coolant to leak out of the coolant cans, as described above, the coolant cans are still “fluidically isolated” from the stator core or rotor, as defined in this disclosure.

Referring again to FIGS. 2-6, in this implementation, the plurality of coolant cans 204 are oriented circumferentially around respective stator teeth 214 of the stator core 202. In this implementation, a first plurality 260 of stator teeth 214 receives a coolant can 204 and, thus, is surrounded by a concentrated winding 250 encapsulated within the coolant can 204. As a result, each of the first plurality 260 stator teeth 214 is associated with a respective pole generated by currents passing through the stator winding 250. A second plurality 262 of stator teeth 214 are each disposed between two coolant cans 204. This configuration reduces an amount of material comprising the body 230 of the coolant can 204 between stator teeth 214 (i.e., the “slot” between stator teeth 214), and, thus, a winding fill factor between stator teeth 214 is maximized. In various implementations, less than about 25% of the slot is filled by coolant can material, less than about 15% of the slot is filled by coolant can material, or less than about 5% of the slot is filled by coolant can material.

Counter to traditional design wherein you attempt to utilize all of the available slot area for windings to maintain high performance, coolant cans may decrease conductor slot fill factor while still providing high performance operation or improving performance. This may increase the current density of the conductor within a machine which is typically associated with lower performance, but still offer performance enhancement as described throughout this application. In other applications, such as highly torque dense applications, coolant cans allow for added magnetic core material when compared to the requisite slot area of a traditional electric machine which enables the machine to lower saturation for the same magnetomotive force, as well as saturate at a higher level for additional electromagnetic performance.

Accordingly, in some implementations, the stator core 202 is configured such that each of the stator teeth 214 receive a coolant can 204, and thus, each of the stator teeth 214 are surrounded by one or more windings 250 encapsulated within the coolant can 204. In such implementations, two or more coolant cans 204 disposed circumferentially adjacent to each other may have a common wall between the bodies 230 of the coolant cans 204. In some implementations, a stator tooth 214 is surrounded by multiple windings 250. In some implementations, a single coolant can 204 spans across and is received by multiple stator teeth 214.

Referring again to FIG. 10, in this implementation, when one of the plurality of coolant cans 204 is positioned on the stator tooth 214, a top portion 270 of the stator tooth 214 extends through the opening 244 of the body 230 and above the top wall 248 of the body 230 of the coolant can 204.

FIG. 12 is a cross-sectional view of the plurality of coolant cans 204 disposed along the circumference of the stator core 202 as taken along line 12-12 of FIG. 2. As seen in FIG. 12, with the coolant can 204 inserted onto one of the first plurality 260 of stator teeth 214, the coolant can 204 contacts one of the second plurality 262 of stator teeth 214 on each side of the coolant can 204, such that a gap is present between the top portions 270 of the stator teeth 214. A gap piece 272 may be inserted between the two top portions 270 of the stator teeth 214 to form a substantially continuous outer surface of the stator 200. In some implementations, the gap piece 272 is comprised of the same material as the stator core 202. In some implementations, the gap piece 272 is comprised of a different material as the stator core 202. In some implementations, the first plurality 260 and the second plurality 262 of stator teeth do not have the same radial height, thus a gap piece 272 is not needed.

As mentioned above, in some electrical machines, it may be beneficial to have windings including coils that overlap and encompass multiple teeth of either a rotor or a stator, i.e., a distributed winding. Some stators or rotors according to this disclosure include distributed windings. In such implementations, because each winding is distributed across much or all of a circumference of the stator or rotor and is interwoven between multiple teeth, the coolant cans that define corresponding coolant flow passages in stators or rotors with distributed windings may have a different structure from those described for concentrated windings.

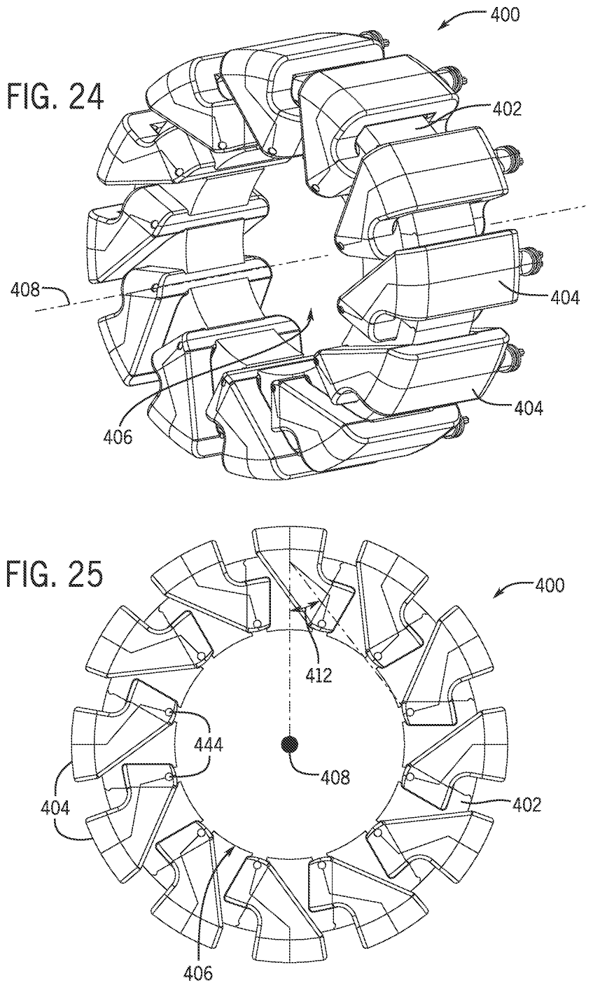

Moreover, in some electrical machines, it may be beneficial to have windings including coils that wrap a tooth slot of either a rotor or a stator around their respective back iron, i.e., a toroidal winding. Some stators or rotors according to this disclosure include toroidal windings (see FIGS. 24-41). In such implementations, because each winding is distributed across the axial components of the motor and around the back iron, the coolant cans that define corresponding coolant flow passages in stators or rotors with toroidal windings may have a different structure from those described for concentrated windings. These may take features similar to either concentrated windings or distributed windings, or in combination.

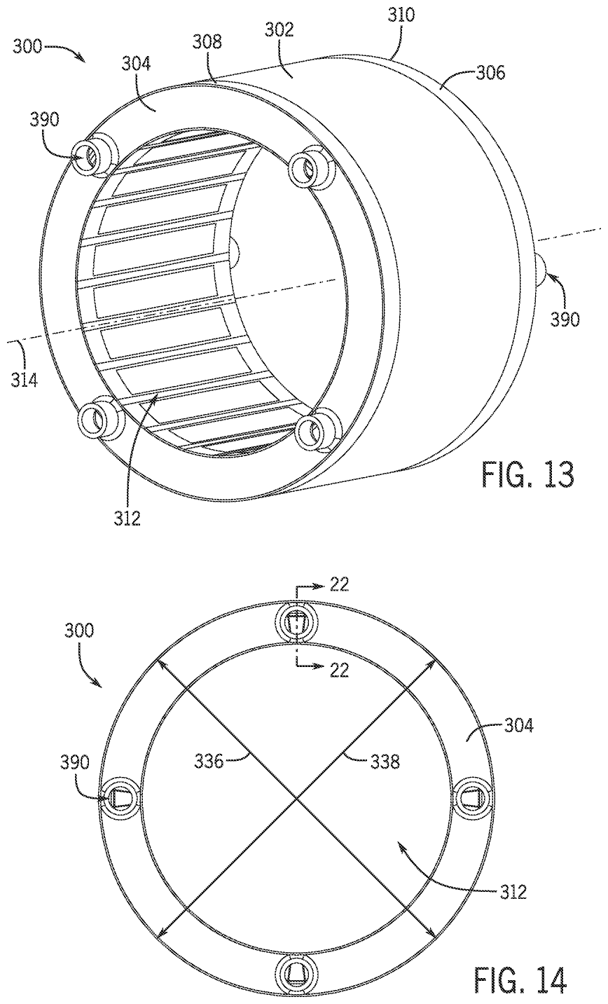

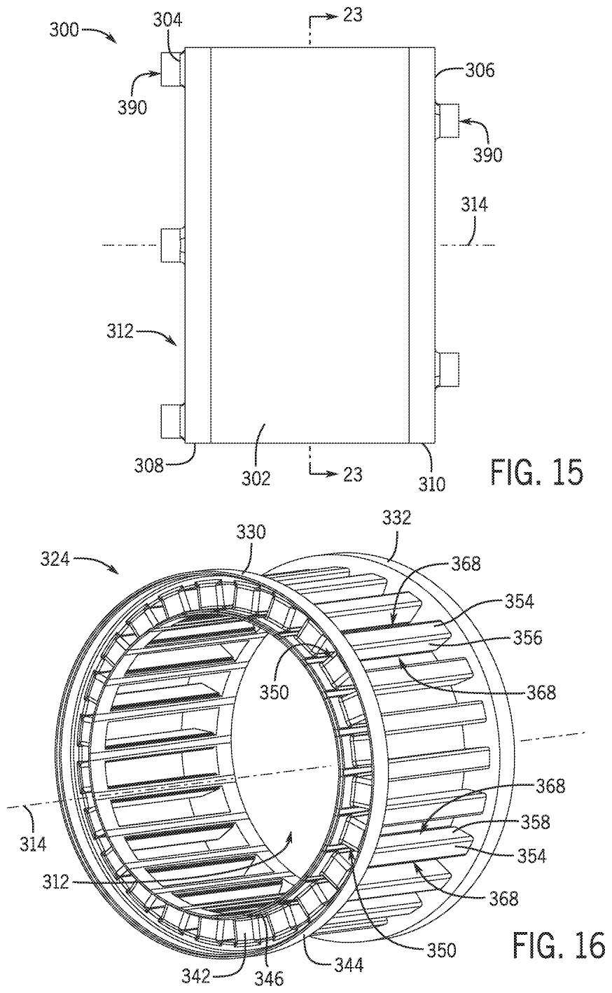

FIGS. 13-23 illustrate an example stator having a thermal management system including coolant cans for distributed windings according to the present disclosure. The coolant cans configured for distributed windings in this implementation share common features with the coolant cans configured for concentrated windings, as described with reference to FIGS. 2-12. However, in this implementation the windings are interconnected through each of the coolant cans of the stator, thus, the coolant cans are not configured to fluidically isolate one coolant can from other coolant cans of the stator.

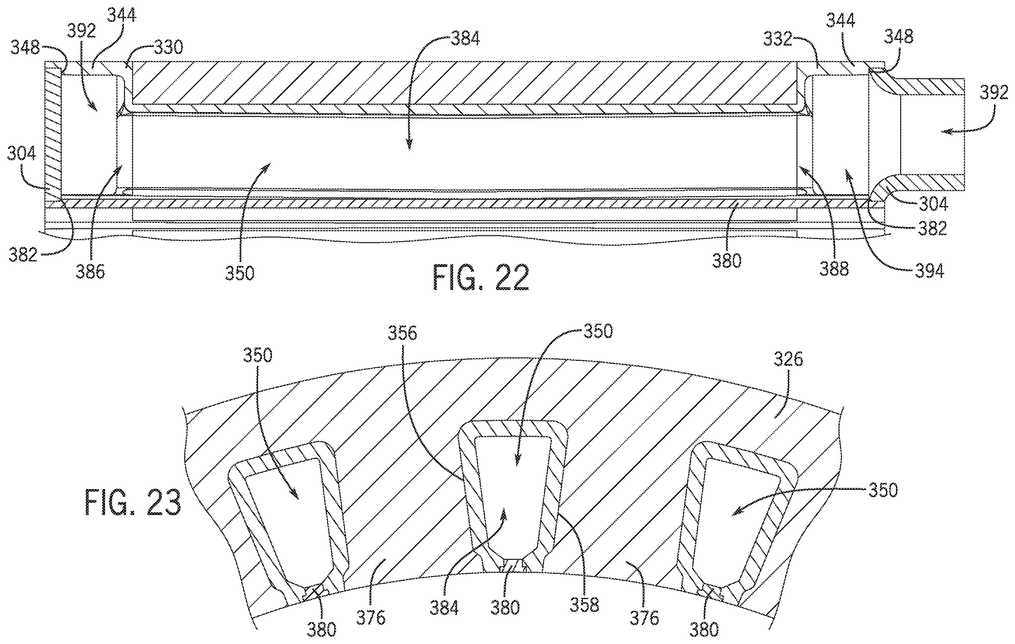

Referring to FIGS. 13-15, an example stator 300 includes a stator core 302 and first and second endcaps 304, 306 disposed on first and second axial ends 308, 310 of the stator core 302, respectively. Similar to the stator 200 of the example implementation described with reference in FIGS. 2-12, the stator 300 includes an opening 312 extending through the axials ends 308, 310 and along a longitudinal axis 314 of the stator core 302 that is configured to receive a rotor (not shown) of the electric motor. In this implementation, the stator core 302 is configured to receive distributed stator windings (not shown) within a plurality of coolant can elements 350 (see FIGS. 22 and 23) disposed within the stator core 302.

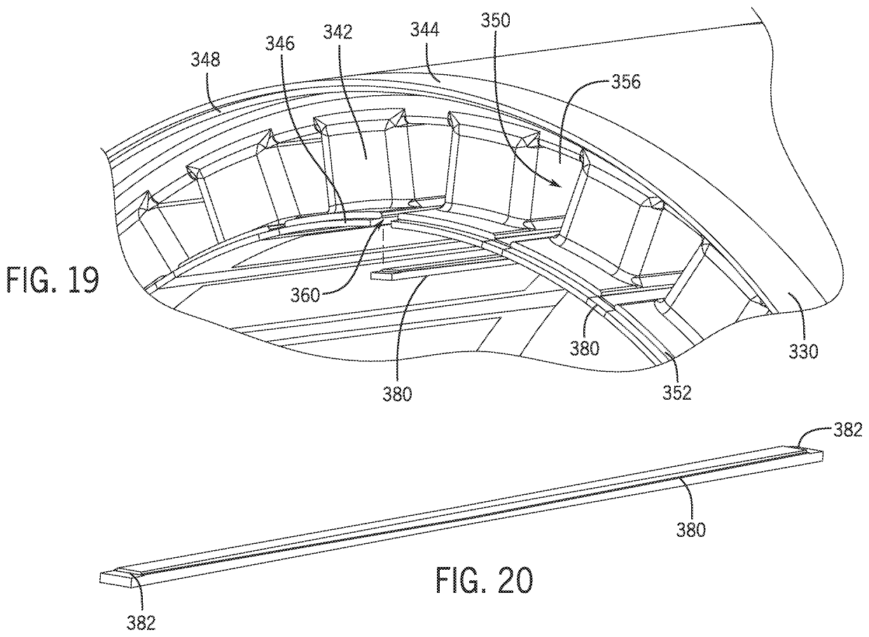

Referring now to FIGS. 16-18, the stator core 302 is comprised of a coolant can frame 324 and a stator core 326, which is disposed on the coolant can frame 324. The coolant can frame 324 includes an opening that defines the opening 312 of the stator 300. The coolant can frame 324 includes a first endcap 330 disposed on the first axial end 308 of the stator core 302 and a second endcap 332 disposed on the second axial end 310. An outer diameter 336 (see FIG. 14) of the first and second endcaps 330, 332 of the coolant can frame 324 define an outer diameter of the stator core 302. An inner diameter 338 (see FIG. 14) of the endcaps 330, 332 are defined by the opening 312 of the stator 300. The first and second endcaps 330, 332 include an interior wall 342 and an outer rim 344 and an inner rim 346 extending axially outward from the interior wall 342. The outer rim 344 having the outer diameter 336 and the inner rim 346 having the inner diameter 336. The outer rim 344 includes an outer recessed edge 348 (see FIG. 19) within the endcaps 330, 332 and extending toward the interior wall 342. The inner rim 346 includes an inner recessed edge 352 (see FIG. 19) within the endcaps 330, 332 and extending toward the interior wall 342 at a distance similar to the distance the outer recessed edge 348 of the outer rim 344 extends toward the interior wall 342.

A plurality of coolant can elements 350 are disposed circumferentially between the inner and outer rims 344, 346 of the endcaps 330, 332 and extend axially through the interior wall 342 of the endcaps 330, 332 of the coolant can frame 324. The coolant can elements 350 face radially inward toward the longitudinal axis 314 of the stator 300, such that an outer wall 354 of the coolant can element 350 is disposed radially within the outer diameter 336 of the endcaps 330, 332. The coolant can element 350 include a first side wall 356 and a second side wall 358, opposite the first side wall 356. An air gap opening 360 (see FIG. 19) is disposed within each coolant can element 350 opposite the outer wall 354 and toward the longitudinal axis 314 of the stator 300. The air gap openings 360 extend axially through the inner rims 346 of the endcaps 330, 332 and are defined by the walls 354, 356, 358 of the coolant can element 350. The walls 354, 356, 358 of the coolant can element 350 and the interior walls 342 of the endcaps 330, 332 define a plurality of stator teeth openings 368, such that one stator teeth opening 368 is disposed next to each side wall 356, 358 of the coolant can element 350.

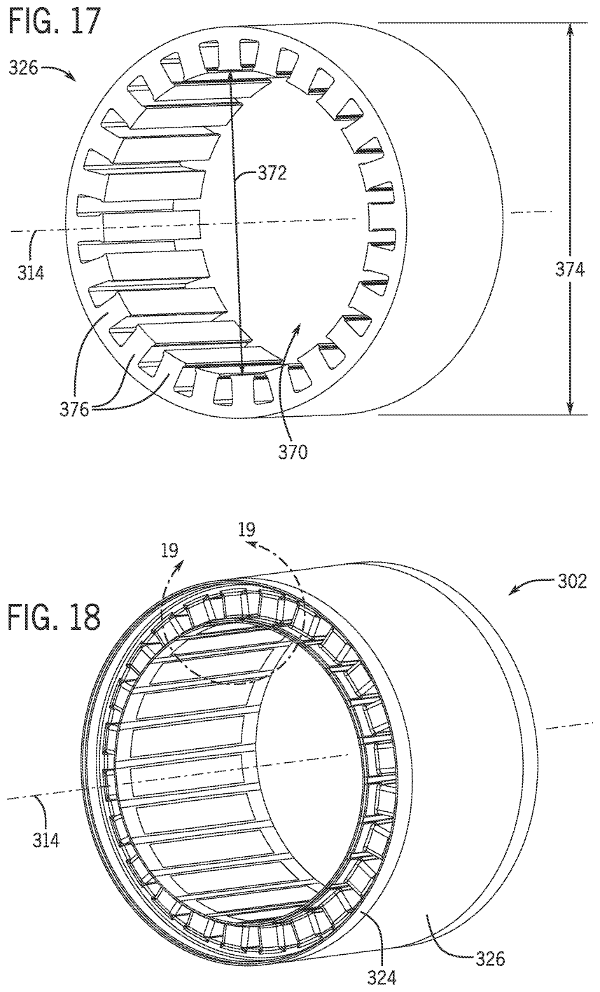

Referring to FIG. 17, the stator core 326 is shown in greater detail. The stator core 326 has an opening 370 extending axially through the longitudinal axis 314 of the stator 300. In this implementation, the stator core 326 has an inner diameter 372 and an outer diameter 374 about the longitudinal axis 314 that are the same as the inner and outer diameters 336, 338 of the coolant can frame 324, respectively. The stator core 326 includes a plurality of stator teeth 376 disposed circumferentially around the inner diameter 372 of the stator core 326 and extend axially through axial ends of the stator core 326. In some implementations, the stator core has inner and outer diameters 372, 374 in which one or both of the diameters 372, 374 are different than the inner and outer diameters 336, 338 of the coolant can frame 324.

In some implementations, the stator core 326 is comprised of a magnetically permeable material, such as iron. In some implementations, the stator core 326 includes stator laminations that reduce eddy currents within the magnetically permeable material of the stator core 326. In some implementations, the stator core 326 includes elements besides a magnetically permeable material. For example, in some implementations the stator core 326 includes adhesives and/or an electrically insulating material (e.g., varnish and/or a metal oxide). In some implementations, portions of the stator core 326 include or are encapsulated in epoxy or another insulating material.

Referring to FIG. 18, the stator core 326 is disposed around the coolant can frame 324 between the endcaps 330, 332. The plurality of stator teeth 376 are received within each of the stator teeth openings 368 of the coolant can frame 324. As shown in FIG. 18, when the stator core 326 is disposed on the coolant can frame 324, the stator teeth 376 define a substantially continuous inner surface of the opening 312 of the stator 300. In this implementation, the stator teeth 376 of are configured such that a portion of each tooth 376 contacts each of the walls 354, 356, 358 of the coolant can element 350 (see FIG. 23).

In some implementations, the coolant can frame 324 is comprised of a single piece. In such implementations, the coolant can frame 324 may be overmolded within the stator core 326. In some implementations, the coolant can frame 324 is comprised of two or more pieces that are joined within the stator core 326. In such implementations, the two or more pieces or the coolant can frame 324 may be joined by one or more of a variety of methods, including ultrasonic welding, adhesives, and mating clips. These methods of joining pieces of the coolant can frame 324 may also be used to join other components of the coolant can frame as described herein.

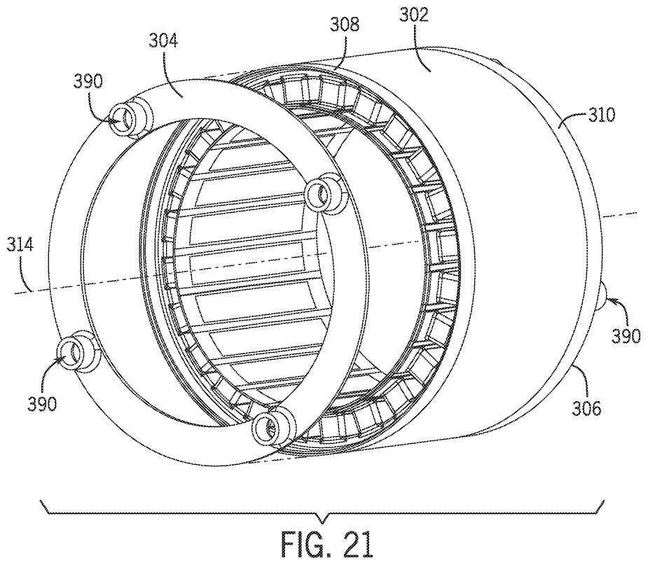

Referring now to FIGS. 19 and 20, the internal structure of the stator core 302 is shown. FIG. 19 shows a detailed view of coolant can frame 324 and the stator core 326 assembled. Distributed windings (not shown) are inserted within each coolant can element 350 via the air gap openings 360 of the coolant can elements 350 with portions of the windings being disposed adjacent the interior walls 342 of the endcaps 330, 332 as the distributed windings extend between the plurality of coolant can elements 350. As shown in FIG. 19, an air gap cap 380 is inserted within each air gap opening 360 of the coolant can elements 350 after the distributed windings (not shown) are inserted. The air gap cap 380 is configured to provide a wall opposite the outer wall 354 in the coolant can elements 350 and includes recessed edges 382 configured to align with the inner recessed edge 352 of the inner rim 346 of the endcaps 330, 332. Thus, once the air gap caps 380 are inserted into the air gap openings 360, the walls 354, 356, 358 and the air gap cap 380 of the coolant can elements 350 define an interior compartment 384 of the coolant can elements 350. The interior compartment 384 of the coolant can elements 350 having an inlet 386 and an outlet 388 defined by the interior walls 342 of the endcaps 330, 332 (see FIGS. 21 and 22).

Referring to FIG. 20, the two endcap pieces 304, 306 are inserted within the inner and outer rims 344, 346 of the endcaps 330, 332. In the illustrated implementation, an inner surface of the endcap pieces 304, 306 contact both the outer recessed edge 348 of the outer rims 344 and the inner recessed edge 352 (including the recessed edges 382 of each of the air gap caps 380 inserted within the air gap openings 360) of the inner rims 346 of the endcaps 330, 332, such that an outer surface of the endcap pieces 304, 306 are flush with the outer and inner rims, 344, 346 of the endcaps 330, 332. In some implementations, the endcap pieces 304, 306 are joined with the coolant can frame 324 as described throughout this disclosure, such as, by welding, adhesives, clips, or other known joining means. In some implementations, a sealing member, such as a gasket, is disposed between the each of the endcap pieces 304, 306 and the coolant can frame 324 to provide a seal between the endcap pieces 304, 306 and the coolant can frame 324.

The endcap pieces 304, 306 include a plurality of openings 390 disposed circumferentially around the endcap pieces. In some implementations, the endcap pieces 304, 306 include the same number of openings 390. In some embodiments, first endcap piece 304 includes more openings 390 than the second endcap piece 306, or vice versa. In some embodiments, one of the endcap pieces 304, 306 includes no openings 390.

Referring now to FIGS. 21 and 22, With the first endcap pieces 304 received by the first endcap 330 an interior compartment 392 of the first endcap 330 is defined by the inner and outer rims 344, 346 and the interior wall 342 of the first endcap 330. Similarly, with the second endcap piece 306 received by the second endcap 332, an interior compartment 394 of the second endcap 332 is defined by the inner and outer rims 344, 346 and the interior wall 342 of the second endcap 332. The openings 390 of the endcap pieces 304, 306 are in fluid communication with the interior compartments 392, 394 of the endcaps 330, 332, respectively. The interior compartments 392, 394 of the endcaps 330, 332 are in fluid communication with each of the interior compartments 384 of the coolant can elements 350 at the inlets and outlets 386, 388 of each coolant can element 350. Thus, the interior compartments 384 of each coolant can element 350 is in fluid communication with each of the other coolant can elements 350.

In some implementations, some coolant can elements 350 may not be in fluid communication with some other coolant can elements 350. In some implementations, some coolant can elements 350 are in fluid communication with only the interior compartment 392 of the first endcap 330 and some coolant can elements 350 are in fluid communication with only the interior compartment 394 of the second endcap 332.

FIG. 21 is a cross-sectional view of a coolant can element 350 taken along line 22-22 of FIG. 14. When coolant is flowed into the interior compartment 392 of the first endcap 330 via the one or more openings 390 of the first endcap piece 330, the coolant flows into the inlet 386 of each of the coolant can elements 350, through the interior compartment 384 and portions of the distributed windings (not shown), and toward the outlet 388 of the coolant can element 350. The coolant flows out of the coolant can element 350 and into the interior compartment 394 of the second endcap 332 via the outlet 388 of the coolant can element 350. The coolant then flows out of the interior compartment 394 of the second endcap 332 via the one or more openings 390 of the second endcap piece 306.

In this implementation, the stator core 326 is fluidically isolated from the coolant flow through the interior compartments 384 of the coolant can elements 350 of the coolant can frame 324. Therefore, the stator core 326 may maintain a higher temperature during motor operation in comparison to conventional forced air, spray, or immersive cooling methods. In some implementations, the coolant can frame 324 is configured to provide coolant to the stator core 326 via additional outlets disposed in the interior compartment 384 of one or more coolant can elements 350 and/or in the interior compartments 392, 394 of the endcaps 330, 332.

In some implementations, the thermal management system having coolant cans for concentrated, distributed, or toroidal windings, as described above, may be applied to either a stator, a rotor, or both in an electrical machine. In some implementations, a stator of an electrical machine can have distributed windings and a rotor of an electrical machine can have concentrated windings, or vice versa. In some implementations, an electrical machine can include concentrated or distributed windings on components other than a stator or a rotor. In some implementations, an electrical machine other than an electric motor may include concentrated or distributed windings.

Some types of electrical machines may require concentrated windings having configurations different than the concentrated winding described with reference to FIGS. 2-12. For example, in some electrical machines electrical wire is wound around a plurality of radial cross-sections of a substantially toroidal shaped component, i.e., concentrated toroidal windings. In some implementations of the present disclosure, an electric machine, such as an electric motor, may include concentrated toroidal windings disposed on a substantially toroidal shaped stator core and/or rotor core. In such implementations, because each concentrated winding is distributed over a radial cross-section of the stator core and/or rotor core, coolant cans configured to encapsulate concentrated toroidal windings may have a different structure those coolant cans configured to encapsulate the concentrated windings described with reference to FIGS. 2-12.

FIGS. 24-32 illustrate an example stator having a plurality of concentrated toroidal windings. The coolant cans configured for the concentrated toroidal windings in this example implementation share common features with the coolant cans configured for the concentrated windings with reference to FIGS. 2-12. However, the concentrated toroidal windings in this implementation differ in shape from the concentrated windings 250 in FIGS. 2-12, thus, the coolant cans in this example implementation differ in shape from the coolant cans 204 of the example implementation in FIGS. 2-12.

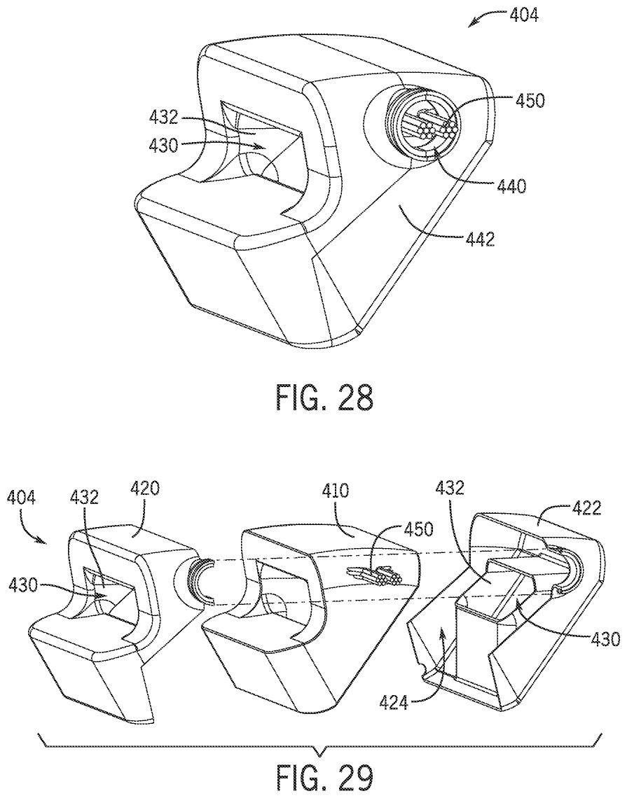

Referring to FIGS. 24-27, a stator 400 includes a stator core 402 and a plurality of coolant cans 404. The stator core 402 has an opening 406 extending through a longitudinal axis 408 of the stator 400. The coolant cans 404 are disposed circumferentially on the stator core 402 about the longitudinal axis 408 of the stator 400. In this implementation, the coolant cans 404 are configured to encapsulate a toroidal concentrated winding 410 (see FIGS. 28 and 29) wound around a cross-section of the stator core 402 at a radial angle 412 relative to the longitudinal axis 408 of the stator 400. In some implementations, the radial angle 412 is less than 45 degrees. In some implementations, the radial angle 412 is in a range of 1 to 10 degrees. In some implementations, the radial angle 412 is in a range of 5 to 15 degrees. In some implementations, the radial angle 412 is in a range of 20 to 35 degrees. In some implementations, the radial angle 412 is in a range of 30 to 45 degrees.

Referring now to FIGS. 28 and 29, the coolant can 404 and the concentrated toroidal winding 410 are shown in greater detail. FIG. 29 illustrates an exploded view of the coolant can 404 having a first piece 420 and a second piece 422. Similar to the body 230 and the lid 252 of the coolant can 204 of the example implementation described in FIGS. 2-12, when the first and second pieces 420, 422 of the coolant can 404 are joined together, the coolant can 404 defines an interior compartment 424 of the coolant can 404. In some implementations, the first and second pieces 420, 422 of the coolant can 404 are joined as described throughout this disclosure, such as, by welding, adhesives, clips, or other known joining means. In some implementations, a sealing member, such as a gasket, is disposed between the first and second pieces 420, 422 of the coolant can 404 to provide a seal between the first and second pieces 420, 422 of the coolant can 404.

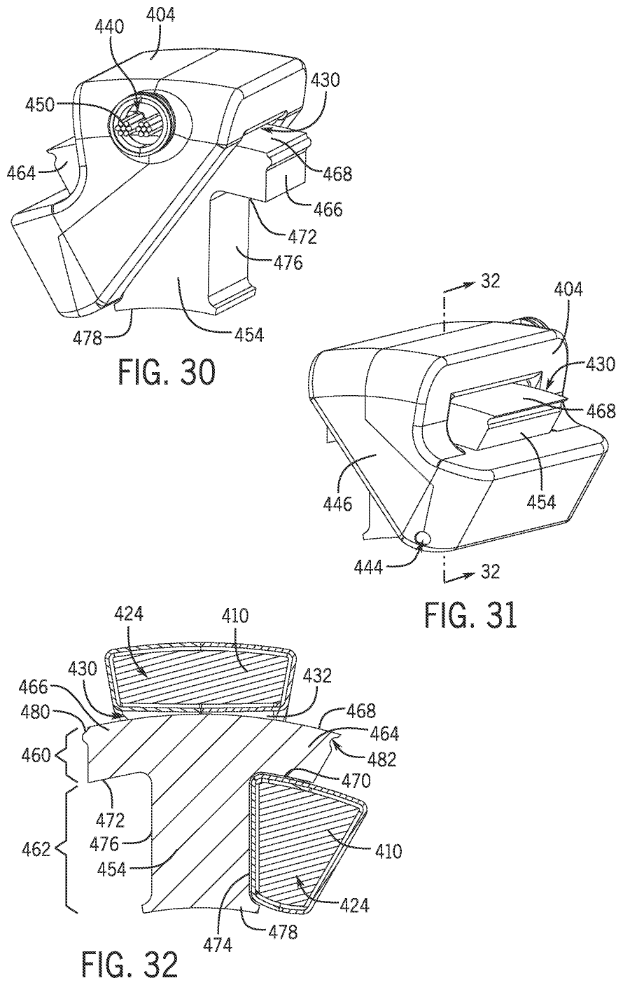

The interior compartment 424 of the coolant can 404 is configured to encapsulate the toroidal winding 410, such that the toroidal winding 410 is fluidically isolated from the stator core 402 and other components of the electric motor. The assembled coolant can 404 includes an opening 430 disposed through the first and second pieces 420, 422 of the coolant can 404 and defines an interior wall 432 extending through the interior compartment 424 of the coolant can 404. The opening 430 of the coolant can 404 is configured to receive a stator segment 436 (see FIGS. 30-32) of the stator core 402. A coolant inlet 440 is disposed on a rear wall 442 of the coolant can 404 and is fluid communication with the interior compartment 424 of the coolant can 404. A coolant outlet 444 is included on a front wall 446 (see FIG. 31) of the coolant can 404 and is in fluid communication with the interior compartment 424 of the coolant can 404.

For purposes of illustration, in FIG. 29, the toroidal winding 410 is depicted as a solid piece with one or more conductors 450 leading away from the toroidal winding 410. The interior compartment 424 of the coolant can 404 is configured to receive the toroidal winding 410 such that the toroidal winding 410 is wrapped around the interior wall 432 of the coolant can 404. In this implementation, the inlet 440 of the coolant can 404 is configured to receive the conductors 450 of the toroidal winding 410 leading out of the coolant can 404 in addition to allowing fluid to flow into the interior compartment 424 of the coolant can 404.

In some implementations, the conductors 450 of each winding 410 is in electrical connection with one or more other components of the thermal management system of the electric machine or other component components of the electric machine. For example, in some implementations, the conductors 450 of each winding 410 is in electrical connection with the conductors 450 of another winding 410 that may be encapsulated in a separate coolant can. In some implementations, the conductors 450 of each winding 410 is in electrical connection with a bus bar. In some implementations, the conductors 450 of each winding 410 is in electrical connection with an active electrical circuit.

The interior compartment 424 of the coolant can 404 defines a fluid flow passage, such that when liquid coolant is flowed into the interior compartment 424 of the coolant can 404 via the inlet 440 the coolant flows through the toroidal winding 410 and out the interior compartment 424 via the outlet 444 of the coolant can 404. In this implementation, the coolant can 404 is fluidically isolated from the stator core 402 such that flow of coolant through the interior compartment 424 of the coolant can 404 contacts the winding 410 but does not contact portions of the stator core 402.

Referring now to FIGS. 30-32, the coolant can 404 disposed on the stator core 402 is shown in greater detail. In this implementation, the stator core 402 is comprised of a plurality of stator segment 454, such that each stator segment 454 corresponds to one of the plurality of coolant cans 404. In this implementation, the stator segment 454 are “T-shaped,” i.e., an upper portion 460 extends perpendicular to a lower portion 462 of the stator segment 454. The upper portion 460 has a first side tooth 464 and a second side tooth 466, opposite the first side tooth 464. The upper portion 460 has an outer surface 468, a first inner side surface 470 of the first side tooth 464, and a second inner side surface 472 of the second side tooth 466. The lower portion 462 has a first side surface 474, a second side surface 476, and an inner surface 478. Each stator segment 454 is configured to receive the opening 430 of one coolant can 404, such that inner surface 434 contacts the upper surface 468, the first inner surface 470, and the first side surface 474 of the stator segment 454.

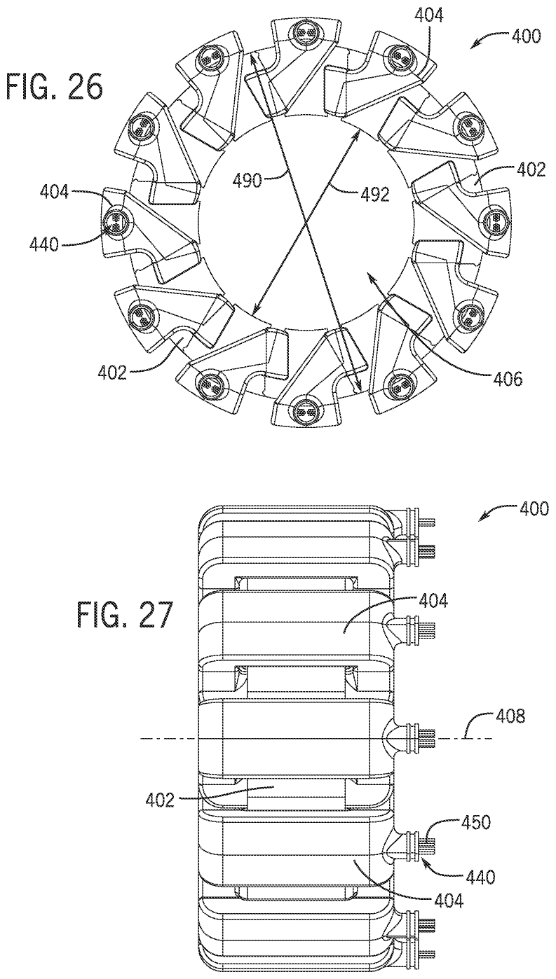

Each stator segment 454 is further configured to mate with two other stator segments 454 disposed circumferentially adjacent to it, such that the assembled stator segments 454 form the stator core 402. In this implementation, the stator segment 454 includes a mating groove 480 and a mating recess 482. The stator 400 is assembled by inserting the mating groove 480 of one stator segment 454 with the mating recess 482 of another stator segment 454. When two stator segments 454 each having coolant cans 404 are mated, the coolant can 404 disposed on one stator segment 454 contacts the second inner side surface 472 and the second side surface 476 of the bottom portion of the other stator segment 454. The outer surfaces 468 of the stator segments 454 are configured to form a substantially continuous outer surface of the stator core 402 having a first diameter 490 (see FIG. 26) when each of the plurality of stator segments 454 are assembled with one another. Likewise, the lower surfaces 478 of the stator segments 454 are configured to form a substantially continuous inner surface of the stator core 402 having a second diameter 492 when each of the plurality of stator segments 454 are assembled with one another.

In some implementations, a ratio between the first and second diameters 490, 492 of the stator core 402 is in a range of 10:9 to 3:2. In some implementations, a ratio between the first and second diameters 490, 492 of the stator core 402 is in a range of 7:5 to 9:5. In some implementations, a ratio between the first and second diameters 490, 492 of the stator core 402 is in a range of 13:10 to 2:1. In some implementations, a ratio between the first and second diameters 490, 492 of the stator core 402 is in a range of 19:10 to 5:2.

In some implementations, the stator segments 454 that form the stator core 402 includes materials and laminations as described for stator cores throughout this disclosure, for example, stator core 326 of FIGS. 13-23.

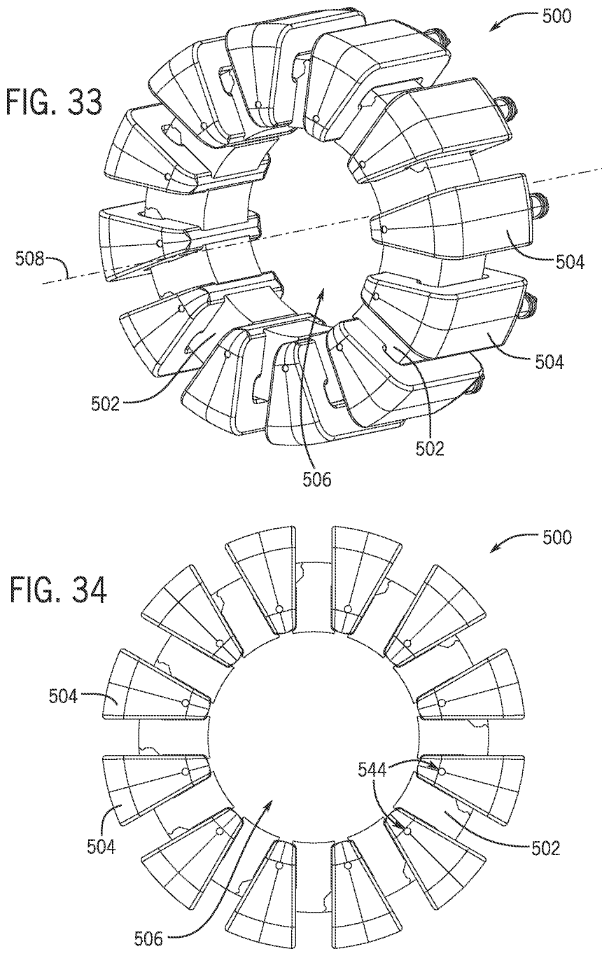

FIGS. 33-41 illustrate another example stator having a plurality of example concentrated toroidal windings that differ from the example concentrated toroidal windings 410 described in FIGS. 24-32. The coolant cans being configured for the concentrated toroidal windings in this example implementation share common features with both the coolant cans 204 configured for the concentrated windings 250 as described with reference to FIGS. 2-12 and with the coolant cans 404 configured for the concentrated toroidal windings 410 as described with reference to FIGS. 24-32. However, the concentrated toroidal windings in this implementation differ in shape from the windings 250, 410 described with reference to FIGS. 2-12 and 24-32, respectively. Thus, the coolant cans in this example implementation differ in shape from the coolant cans 204, 404 described with reference to FIGS. 2-12 and 24-32, respectively. Moreover, the stator segments in this example implementation differ in shape from the stator segments 454 described with reference to FIGS. 24-32.

Referring to FIGS. 33-36, a stator 500 includes a stator core 502 and a plurality of coolant cans 504. The stator core 502 has an opening 506 extending through a longitudinal axis 508 of the stator 500. The coolant cans 504 are disposed circumferentially on the stator core 502 about the longitudinal axis 508 of the stator 500. In this implementation, the coolant cans 504 are configured to encapsulate a concentrated toroidal winding 510 (see FIG. 38) that is wound around a cross-section of the stator core 502 and radially aligned with the longitudinal axis 508 of the stator 500, instead of at the radial angle 412 to the longitudinal axis 408 like the toroidal winding 410 described with reference to FIGS. 24-32.

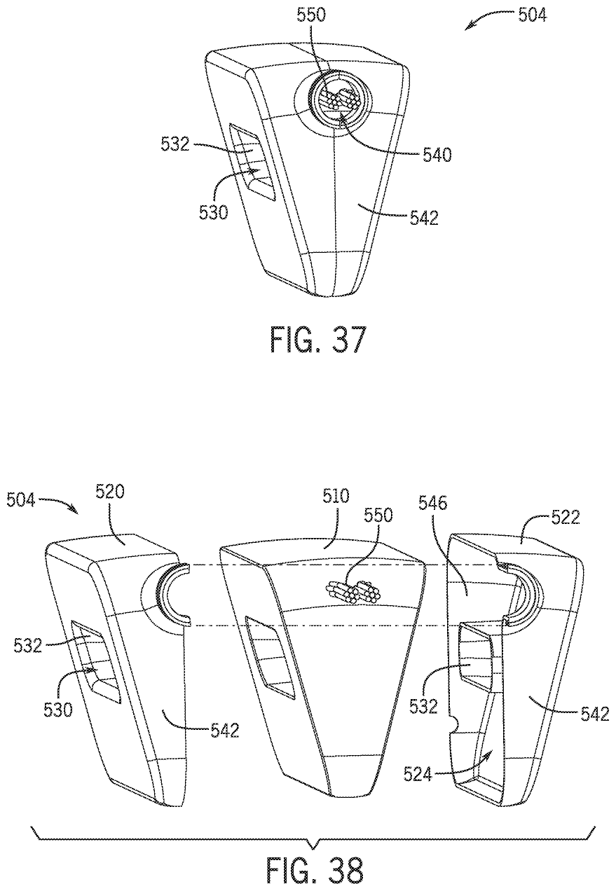

Referring now to FIGS. 37 and 38, the coolant can 504 and the toroidal winding 510 are shown in greater detail. FIG. 38 illustrates an exploded view of the coolant can 504 having a first piece 520 and a second piece 522. Similar to the coolant can 404 of the example implementation with reference to FIGS. 24-32, when the first and second pieces 520, 522 of the coolant can 504 are joined together, the coolant can 504 defines an interior compartment 524 of the coolant can 504. In some implementations, the first and second pieces 520, 522 of the coolant can 504 are joined as described throughout this disclosure, such as, by welding, adhesives, clips, or other known joining means. In some implementations, a sealing member, such as a gasket, is disposed between the first and second pieces 520, 522 of the coolant can 504 to provide a seal between the first and second pieces 520, 522 of the coolant can 504.

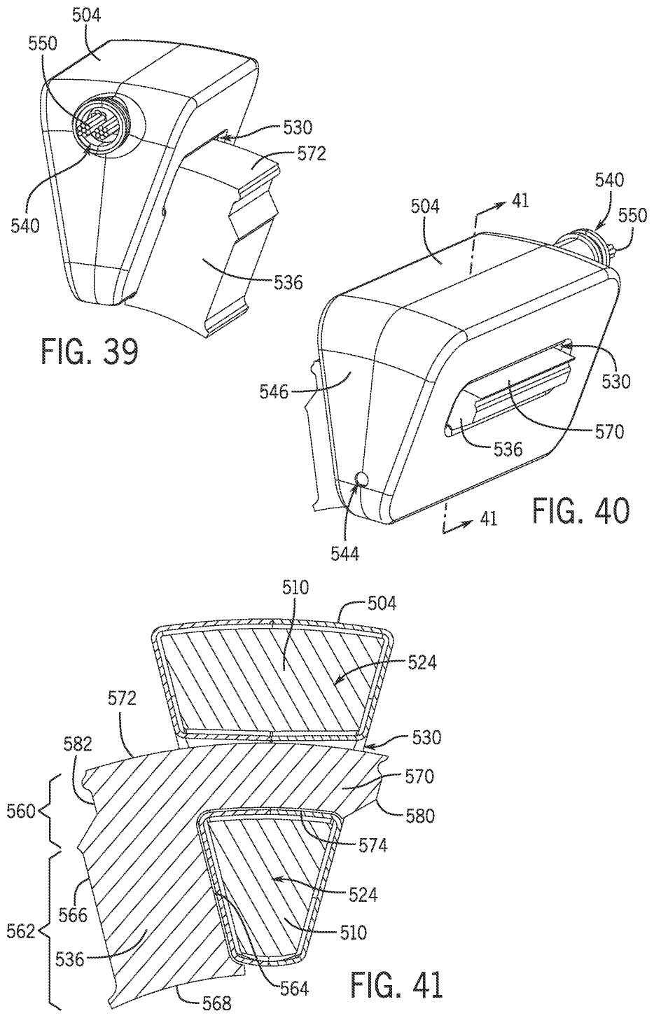

The interior compartment 524 of the coolant can 504 is configured to encapsulate the toroidal winding 510 such that the toroidal winding 510 is fluidically isolated from the stator core 502 and other components of the electric motor. The assembled coolant can 504 includes an opening 530 disposed through the first and second pieces 520, 522 of the coolant can 504 and defines an interior wall 532 extending through the interior compartment 524 of the coolant can 504. The opening 530 of the coolant can 504 is configured to receive a stator segment 536 (see FIGS. 39-41) of the stator core 502. A coolant inlet 540 is disposed on a rear wall 542 of the coolant can 404 and is fluid communication with the interior compartment 524 of the coolant can 504. A coolant outlet 544 is disposed on a front wall 546 (see FIG. 40) of the coolant can 504 and is in fluid communication with the interior compartment 524 of the coolant can 504.

For purposes of illustration, in FIG. 38, the toroidal winding 510 is depicted as a solid piece having one or more conductors 550 leading away from the toroidal winding 510. The interior compartment 524 of the coolant can 504 is configured to receive the toroidal winding 510, such that the toroidal winding 510 is wrapped around the interior wall 532 of the coolant can 504. In this implementation, the inlet 540 of the coolant can 504 is configured to receive the conductors 550 of the toroidal winding 510 leading out of the coolant can 504 in addition to allowing fluid to flow into the interior compartment 524 of the coolant can 504.

In some implementations, the conductors 550 of each winding 510 is in electrical connection with one or more other components of the thermal management system of the electric machine and/or other component components of the electric machine. For example, in some implementations, the conductors 550 of each winding 510 is in electrical connection with the conductors 550 of another winding 510 that may be encapsulated in a separate coolant can. In some implementations, the conductors 550 of each winding 510 is in electrical connection with a bus bar. In some implementations, the conductors 550 of each winding 510 is in electrical connection with an active electrical circuit.

The interior compartment 524 of the coolant can 504 defines a fluid flow passage, such that when liquid coolant is inserted into the interior compartment 524 of the coolant can 504 via the inlet 540 the coolant flows through the toroidal winding 510 and out the interior compartment 524 via the outlet 544 of the coolant can 504. In this implementation, the coolant can 504 is fluidically isolated from the stator core 502 such that flow of coolant through the interior compartment 524 of the coolant can 504 contacts the winding 510 but does not contact the stator core 502 or the stator segments 536.

Referring now to FIGS. 39-41, the coolant can 504 disposed on a portion of the stator core 502 is shown in greater detail. Similar to the example implementation described with reference to FIGS. 24-32, the stator core 502 is comprised of a plurality of stator segments 536, such that each stator segment 536 corresponds to one of the plurality of coolant cans 504. The stator segments 536 in this example implementation are “L-shaped,” while the stator segments 436 in the example implementation described with reference to FIGS. 24-32 are “T-shaped.” The stator segment 536 has an upper portion 560 and a lower portion 562. The lower portion 562 has a first side surface 564, a second side surface 566, and an inner surface 568. The upper portion 560 has a tooth 570 extending perpendicular from the lower portion 562, an upper surface 572, and a lower surface 574. The tooth 570 is configured to receive the opening 530 of the coolant can 504, such that the interior wall 532 of the coolant can 504 contacts the upper surface 572, the lower surface 574, and the first side surface 564.

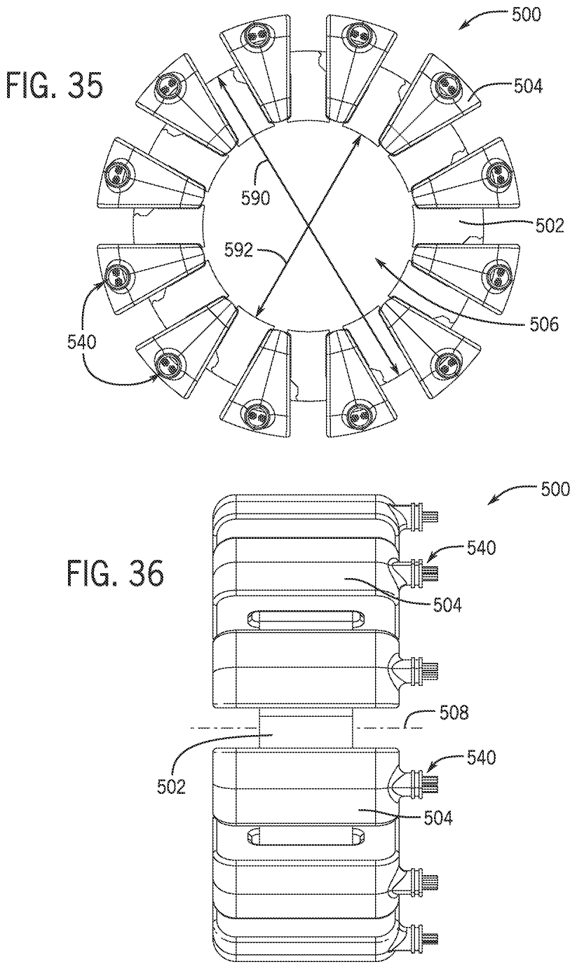

Each stator segment 554 is further configured to mate with two other stator segments 554 disposed circumferentially adjacent to it, such that the assembled stator segments 554 form the stator core 502. In this implementation, the stator segment 554 includes a first mating surface 580 and a second mating surface 582, configured to mate with the first mating surface 580. The stator 500 is assembled by inserting the first mating surface 580 of one stator segment 554 with the second mating surface 582 of another stator segment 554. Unlike the coolant cans 404 and the stator segments 454 of FIGS. 24-32, when two stator segments 554 each having coolant cans 504 are mated, the coolant can 504 disposed on one segment 554 does not contact the stator segment 554 of the other mated segment 554. The outer surfaces 572 of the stator segments 554 are configured to form a substantially continuous outer surface of the stator core 502 having a first diameter 590 (see FIG. 35) when each of the plurality of stator segments 554 are assembled with one another. Likewise, the lower surfaces 568 of the stator segments 554 are configured to form a substantially continuous inner surface of the stator core 502 having a second diameter 592 when each of the plurality of stator segments 554 are assembled with one another.

In some implementations, a ratio between the first and second diameters 590, 592 of the stator core 502 is in a range of 10:9 to 3:2. In some implementations, a ratio between the first and second diameters 590, 592 of the stator core 502 is in a range of 7:5 to 9:5. In some implementations, a ratio between the first and second diameters 590, 592 of the stator core 502 is in a range of 13:10 to 2:1. In some implementations, a ratio between the first and second diameters 590, 592 of the stator core 502 is in a range of 19:10 to 5:2.

According to the present disclosure, the thermal management system including coolant cans for concentrated toroidal windings, as described above, may be applied to either a stator, a rotor, or both in an electrical machine. In some implementations, a stator of an electrical machine can have concentrated toroidal windings and a rotor of an electrical machine can have concentrated or distributed windings, or vice versa. In some implementations, an electrical machine can include concentrated toroidal windings on components other than a stator or a rotor.

As described throughout the present disclosure, it may be beneficial to provide a thermal management system for an electric motor including coolant cans on a rotor of the electric motor. Induced currents in windings of a rotor dissipate heat as described throughout this disclosure. Induced eddy currents in the rotor core represent loss of performance, such that it may be desirable to cool the rotor windings while maintaining the rotor core at a relatively high temperature to reduce eddy current generation. For example, one or more portions of the rotor core may have a higher temperature than one or more windings of the rotor during operation of the electric motor. Accordingly, in some implementations of the present disclosure, a rotor of an electric motor can include windings encapsulated by one or more coolant cans, rather than or in addition to coolant cans disposed on a stator of the electric motor.

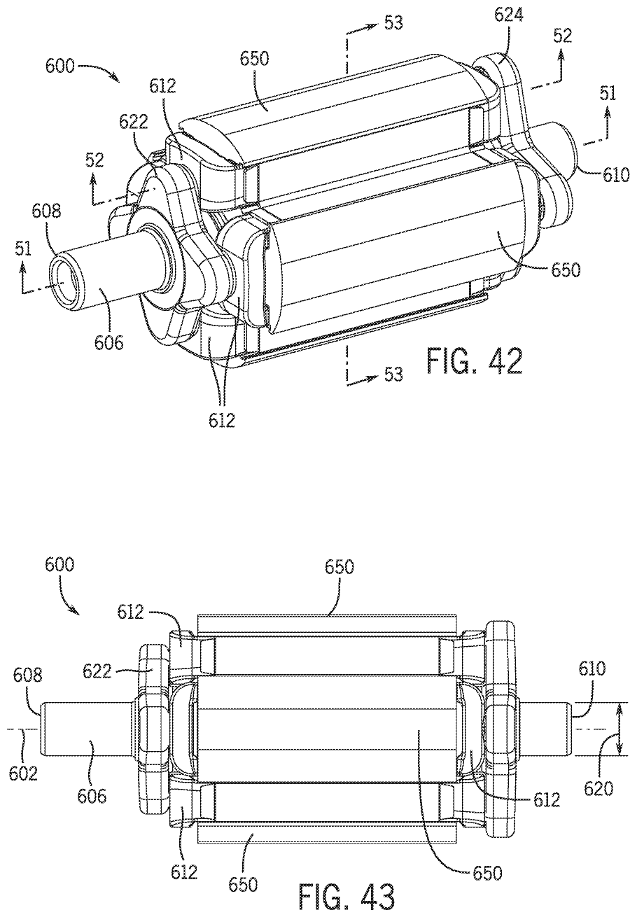

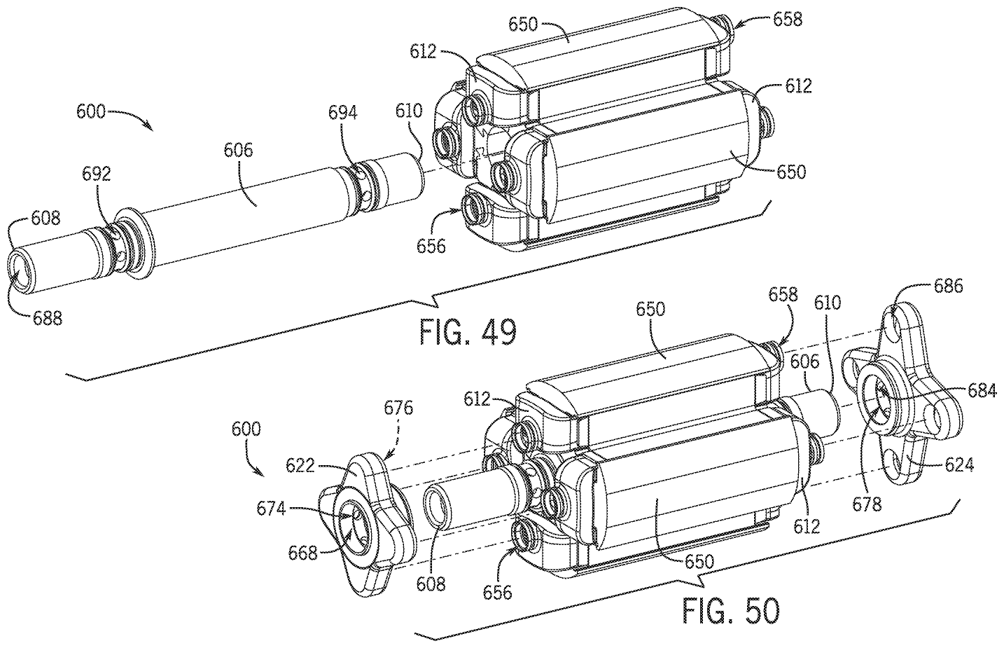

FIGS. 42-53 illustrate an example rotor having one or more coolant cans encapsulating windings of the rotor. The example rotor 600 is configured to be received and rotate within an opening of a stator (not shown), for example, the opening 210 of the stator 200 with reference to FIGS. 2-12. The rotor 600 is symmetrical about a longitudinal axis 602 of the rotor 600 such that the rotor 600 is balanced as it rotates about the longitudinal axis 602. A variety of rotor and rotor can topologies (including paths for coolant flow) are within the scope of this disclosure.

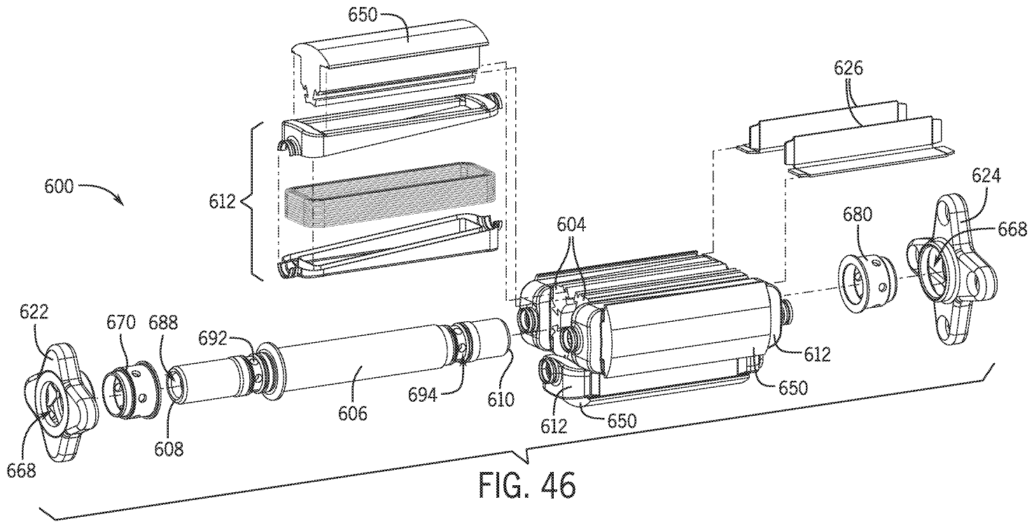

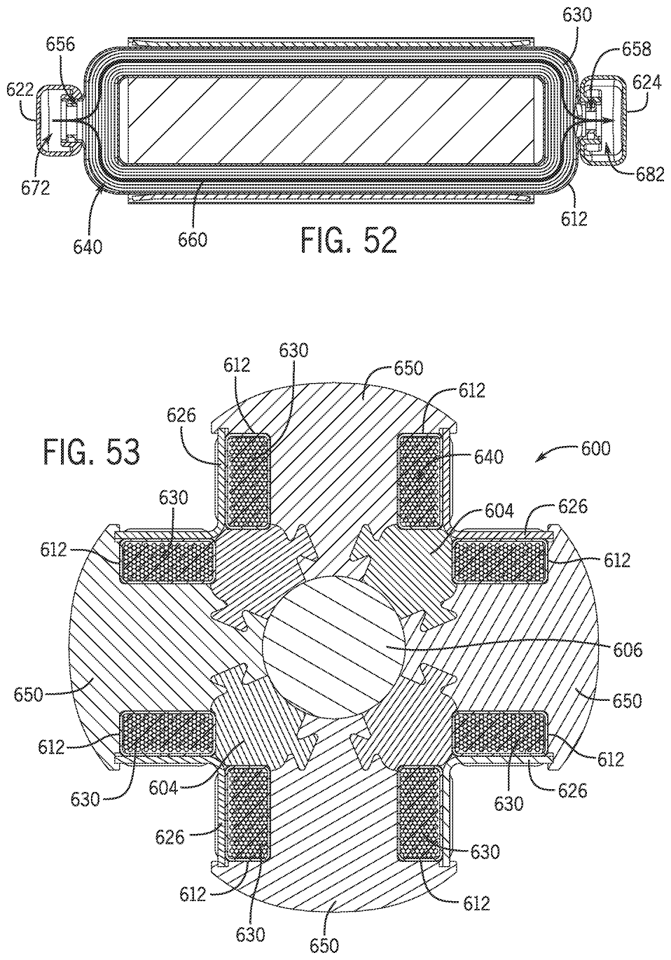

Referring now to FIG. 46, an exploded view of the rotor 600 is illustrated. In the illustrated example implementation, the rotor 600 includes a rotor core 604 (see FIG. 52), a shaft 606 having a first end 608 and a second end 610, and a plurality of coolant cans 612 disposed circumferentially around a rotor core 614. The rotor core 614 is configured to receive an outer diameter 620 of the shaft 606, the plurality of coolant cans 612, and a plurality of rotor poles 650. In some implementations, the rotor core 614 is comprised of a magnetically permeable material, such as iron. In some implementations, the rotor core 614 includes rotor laminations that reduce eddy currents within the magnetically permeable material of the rotor core 614. In some implementations, the rotor core 614 includes elements besides a magnetically permeable material. For example, in some implementations the rotor core 614 includes adhesives and/or an electrically insulating material (e.g., varnish and/or a metal oxide). In some implementations, portions of the rotor core 614 include or are encapsulated in epoxy or another insulating material.

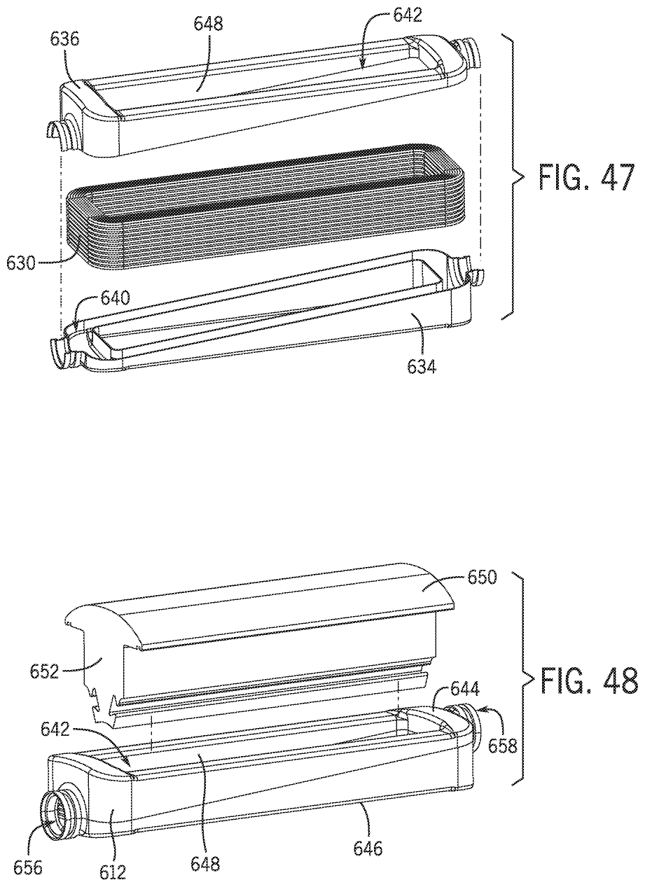

A first endcap 622 is received by the first end 608 of the shaft 606 and a second endcap 624 is received by the second end 610 of the shaft 606. A plate 626 is disposed between each side of the coolant cans 612 and is configured to support the coolant cans 612 as the rotor 600 rotates. The coolant cans 612 are configured to encapsulate one or more windings 630 of the rotor 600 (see FIGS. 47 and 48). In this implementation, four coolant cans 612 are included in the rotor 600 and the coolant cans 612 are disposed in a square pattern around the rotor core 614. In some implementations, no more than three coolant cans 612 are included in the rotor 600. In some implementations, more than four coolant cans are included in the rotor 600.

Referring now to FIGS. 47 and 48, the coolant can 612 includes a lower piece 634 and an upper piece 636. When the lower and upper pieces 634, 636 of the coolant can 612 are joined, the pieces 634, 636 define an interior compartment 640 of the coolant can 612. The interior compartment 640 is configured to encapsulate the winding 630. The pieces 634, 636 may be joined by one or more of a variety of methods, including ultrasonic welding, adhesives, and mating clips. These methods of joining the pieces 634, 636 of the coolant can 612 may also be used to join other portions of the coolant can 612 described herein. In some implementations, a sealing member, such as a gasket, may be disposed between the pieces 634, 636 to provide a fluid seal between the pieces 634, 636 of the coolant can 612.

The coolant can 612 includes an opening 642 extending through a top wall 644 and a bottom wall 646 of the coolant can 612. The opening 642 defines an interior wall 648 of the coolant can 612 and is configured to receive a lower portion 652 of a rotor pole 650.

The coolant can 612 includes an inlet 656 and an outlet 658 that are each in fluid communication with the interior compartment 640 of the coolant can 612. The interior compartment 640 defines a liquid flow path 660 such that when coolant is flowed into the interior compartment 640 via the inlet 656 the coolant flows through the winding 630 and out the interior compartment 640 via the outlet 658 of the coolant can 612.

FIG. 53 shows a cross-section of the assembled rotor 600 along line 53-53 of FIG. 42. The respective rotor pole 650 of the coolant cans 612 couple to the rotor core 604 near the shaft 606. In some implementations, the rotor poles 650 are comprised of a magnetically permeable material, such as iron. In some implementations, the rotor poles 650 are comprised of the same material as the rotor core 614. In some implementations, the rotor poles 650 include rotor laminations that reduce eddy currents within the magnetically permeable material of the rotor pole 650 or the rotor core 614.

The first endcap 622 is received by the first end 608 of the shaft 606 through a hole 668 of the endcap 622. A first collar 670 is disposed between the hole 668 of the first endcap 622 and the shaft 606. The first endcap 622 has an interior compartment 672 with a plurality of inlet holes 674 disposed circumferentially around the hole 668 that are in fluid communication with the interior compartment 672 of the first endcap 622. In this implementation, a plurality of outlet holes 676 are disposed at a radial distance from the hole 668 and are in fluid communication with the interior compartment 672 of the first endcap 622. The outlet holes 676 of the first endcap 622 are configured to couple with the inlets 656 of the coolant cans 612. In other implementations, the first endcap 622 includes a number of outlet holes 676 that is greater than a number of coolant cans 612 of the rotor 600. In some implementations, the first endcap 622 includes a number of outlet holes 676 that is less than a number of coolant cans 612 of the rotor 600.

Similarly, the second endcap 624 is received by the second end 610 of the shaft 606 through a hole 678 of the endcap 624. A second collar 680 is disposed between the hole 678 of the second endcap 624 and the shaft 606. The second endcap 624 has an interior compartment 682 with a plurality of outlet holes 684 disposed circumferentially around the hole 678 that are in fluid communication with the interior compartment 682 of the second endcap 624. In this implementation, a plurality of inlet holes 686 are disposed at a radial distance from the hole 678 and are in fluid communication with the interior compartment 682 of the second endcap 624. The inlet holes 686 of the second endcap 624 are configured to couple with the outlets 658 of the coolant cans 612. In other implementations, the second endcap 624 includes a number of inlet holes 686 that is greater than a number of coolant cans 612 of the rotor 600. In some implementations, the second endcap 624 includes a number of inlet holes 686 that is less than a number of coolant cans 612 of the rotor 600.

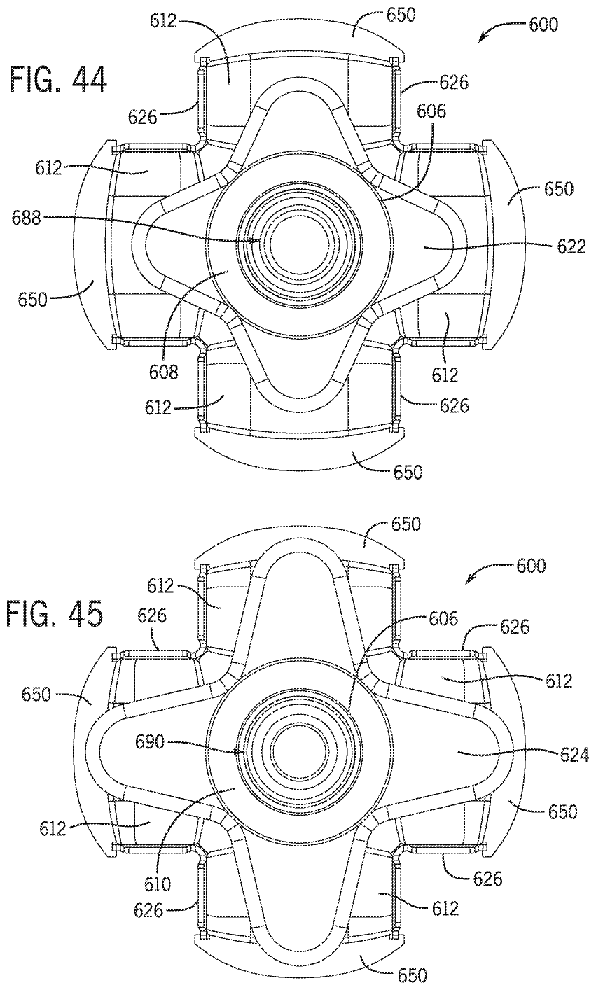

When the rotor 600 is assembled, the interior compartment 672 of the first endcap 622 is in fluid communication with the interior compartment 640 of each of the coolant cans 612 via the inlets 656 of the coolant cans 612 and the second endcap is in fluid communication with the interior compartment 640 of each of the coolant cans 612 via the outlets 658 of the coolant cans 612. Thus, the interior compartments 672, 682 of the first and second endcaps 622, 624 are in fluid communication with each other (see FIG. 52). In this implementation, the inlets 656 of the coolant cans 612 have a smaller radial height than the outlets 658 of the coolant cans 612 (see FIGS. 44 and 45). Thus, the outlet holes 676 of the first endcap 622 extend radially outward at a distance smaller than a distance than the inlet holes 686 of the second endcap 624 extend radially (see FIGS. 44 and 45). This configuration may provide increased efficiency of cooling within the coolant cans as coolant with a higher temperature, and thus a reduced fluid density, flows radially outward from the coolant with a lower temperature and toward the outlet of coolant can. In some implementations, the inlets and outlets 656, 658 of the coolant cans 612 have the same radial height relative to the longitudinal axis 602 of the rotor 600.

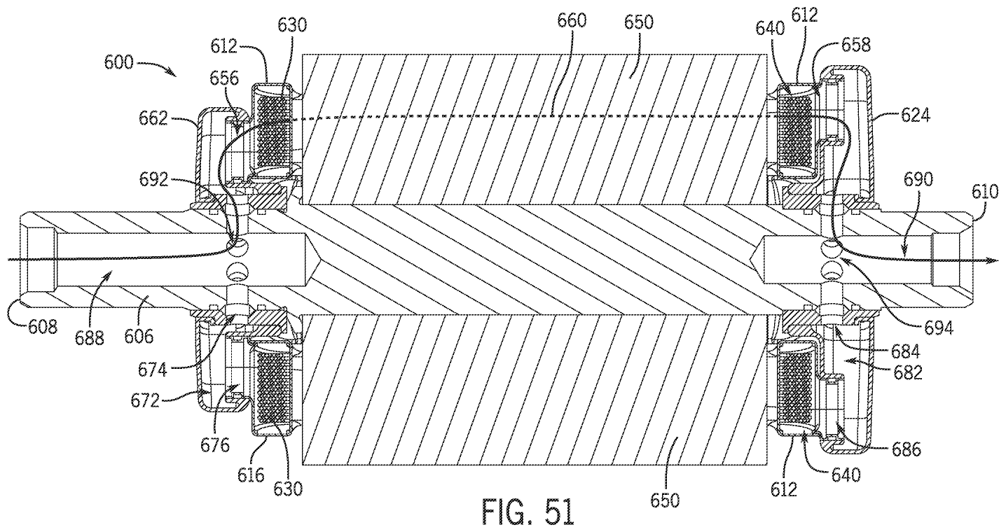

FIG. 51 shows a cross-section of the assembled rotor 600 taken along the line 51-51 of FIG. 42. As shown in FIG. 51, the shaft 606 includes a first counterbore 688 disposed at the first axial end 608 of the shaft 606 and extends axially along the longitudinal axis 602 of the shaft 606. A second counterbore 690 is disposed at the second axial end 610 of the shaft 606 and extends axially along the longitudinal axis 602 of the shaft 606. In this implementation, the first and second counterbores 688, 690 extend at a distance such that the first and second counterbores do not extend axially into each other

A plurality of outlet holes 692 are disposed circumferentially on the shaft 606 near the first end 608 and extend into the first counterbore 688. The plurality of inlet holes 692 are configured to align with the inlet holes 674 of the first endcap 622, such that the first counterbore 688 is in fluid communication with the interior compartment 672 of the first endcap 622 when the rotor 600 is assembled. Likewise, a plurality of outlet holes 694 are disposed circumferentially on the shaft 606 near the second end 610 and extend into the second counterbore 690. The plurality of outlet holes 694 are configured to align with the outlet holes 684 of the second endcap 624, such that the second counterbore 690 is in fluid communication with the interior compartment 682 of the second endcap 624 when the rotor 600 is assembled. Thus, in this implementation, the first counterbore 688 is in fluid communication with the second counterbore 690 when the rotor 600 is assembled through the interior compartments 672, 682 of the endcaps 622, 624 and the interior compartments 640 of the coolant cans 612.

Still referring to FIG. 51, in operation the rotor 600 rotates about the longitudinal axis 602 and coolant is flowed into the first counterbore 688, which acts as a main inlet of the rotor 600. The coolant flows radially outward within the first counterbore 688 through the outlet holes 692 of the shaft 606 and into the interior compartment 672 of the first endcap 622 via the inlet holes 674 of the first endcap 622. The coolant flows radially outward within the interior compartment 672 of the first endcap 622 (as a result of the rotation of the rotor 600 during operation) and toward the outlet holes 676 of the first endcap 622. The coolant flows into the interior compartment 640 of each of the coolant cans 612 via the outlet holes 676 of the first endcap 622 and the inlets 656 of the coolant cans 612. The coolant flows through each of the interior compartments 640 of the coolant cans 612 and through each of the windings 630 disposed within the interior compartments 640 encapsulated within the coolant cans 612. The coolant flows out of the coolant cans 612 and into the interior compartment 682 of the second endcap 624 via the outlets 658 of the coolant cans and the inlet holes 686 of the second endcap 624. The coolant then flows into the second counterbore 690 via the outlet holes 678 of the second endcap 624 and the inlet holes 694 of the shaft 606. In this example implementation, the second counterbore 690 acts as a main outlet of the rotor 600 and the coolant flows out of the second counterbore 690.

In some implementations, the rotor 600 is configured such that the main outlet of the rotor 600 is in fluid communication with the working volume of the motor. In some implementations, the coolant cans 612 include additional outlets in addition to the outlets 658 that are configured to facilitate flow of coolant out of the coolant can 612, other than through the outlets 658. For example, the coolant cans 612 can be configured to provide spray cooling of coolant to the stator (not shown) or other components of the motor.

FIGS. 42-53 illustrate one example of a rotor including coolant cans encapsulating rotor windings; however, various other implementations are within the scope of this disclosure. For example, the number of coolant cans and the number of windings encapsulated by a coolant can may vary. Rotor windings may include concentrated toroidal windings or distributed windings. Flow paths for coolant may be different (e.g., coolant may flow into and/or out of the rotor cans through paths that do not pass through the shaft). The particular mechanisms and structures of component-to-component fluidic coupling and sealing may be implemented differently than as described in reference to FIGS. 42-53. In some implementations, one or more features described herein regarding coolant cans of a stator may be applied to coolant cans of a rotor.

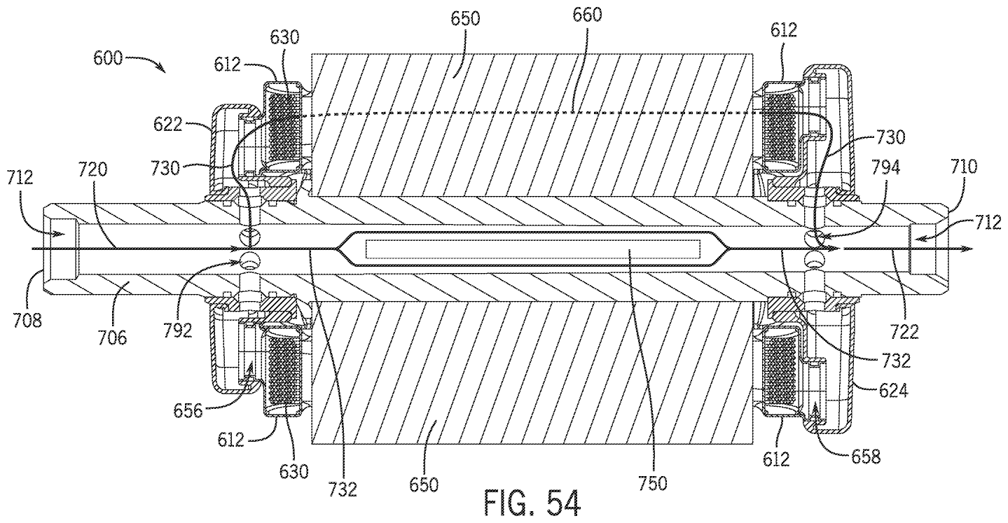

In some implementations, it may be beneficial to provide a thermal management system that provides cooling to electrical components other than windings. For example, FIG. 54 illustrates an example implementation of a thermal management system for the rotor 600 of the electric motor, as described with reference to FIGS. 42-53, but providing additional cooling to other electrical components of the rotor 600. The rotor in the example implementation of FIG. 54 functions substantially the same as the rotor 600 of the example implementation described in FIGS. 42-53. Moreover, the rotor core, rotor poles, the coolant cans, and the endcaps of FIG. 54 have the same structure and function as the rotor core 614, the rotor pole 650, the coolant cans 612, and the endcaps 622, 624 in the implementation described in FIGS. 42-53. Thus, like reference numbers for these components are used in FIG. 54. However, the shaft in this example implementation differs from the shaft 606 of the example implementation described in FIGS. 42-53.

In the illustrated example implementation of FIG. 54, a shaft 706 includes a through hole 712 extending along the longitudinal axis 602 of the rotor 600 and through the first and second axial ends 708, 710 of the shaft 706. The shaft 706 of this implementation differs from the shaft 606 of FIGS. 42-53 in that the through hole 715 of shaft 706 is used in place of the first and second counterbores 688, 690 of the shaft 606. A main inlet 720 is defined by the through hole 715 at the first end 708 of the shaft 706. A main outlet 722 of the rotor 600 is defined by the through hole 715 at the second end 710 of the shaft 706. The main inlet and outlet 720, 722 are in direct fluid communication with one another via the through hole 712.

Still referring to FIG. 54, when a volume of liquid coolant flows into the main inlet 720 at a first end 708 of the rotating shaft 706, a first portion of the volume of liquid coolant flows along a first flow path 730 and, simultaneously, a second portion of the volume of liquid coolant flows along a second flow path 732. The first flow path 730 diverges from the second flow path 732 at a plurality of outlet holes 792 of the shaft 706 near the first end 708. From the outlet holes 792 of the shaft 706, the first flow path 730 is identical to the flow path described in the example implementation of FIGS. 42-53 (see FIG. 51). The second flow path 732 is defined as flow into the main inlet 720 of the shaft 706 at the first axial end 708 and along the through hole 712 toward the main outlet 722 at the second end 710 of the shaft 706. The first and second flow paths 730, 732 merge with one another at a plurality of inlet holes 794 of the shaft 706 toward the second end 710, and a portion or all of the volume of liquid coolant flows out of the through hole 712 via the main outlet 722 of the shaft 706.

In this implementation, an electrical component 750 is disposed within the through hole 712 of the shaft 706 between the plurality of inlet and outlet holes 792, 794 of the shaft 706, i.e. along the second flow path 732. Thus, the second portion of the volume of coolant flows toward and around the electrical component 750 and provides cooling to the electrical component 750 while the first portion of the volume of coolant provides cooling to the windings 630 within the coolant cans 612 of the rotor 600. This implementation may be beneficial because the second portion of the volume of coolant is not exposed to the high temperatures of the windings 630, which are cooled by the first portion of the volume of coolant.

In some implementations, the first and second portions of the volume of coolant have the same volume. In some implementations, the first portion of the volume of coolant is larger than the second portion of the volume of coolant, or vice versa. In some implementations, the through hole 712 of the shaft 706 has cross-sections with different diameters. For example, portions of the through hole 712 of the shaft 706 near the main inlets and outlets 720, 722 may have a larger diameter than a middle portion of the through hole 712 of the shaft 706 disposed between the aforementioned portions of the through hole 712, or vice versa.

In some implementations, the rotor 600 may include three or more parallel coolant flow paths through the rotor 600. Additionally, electrical components may be disposed within any coolant flow path through the rotor 600. For example, with reference to FIG. 51, electrical components may be disposed within the first counterbore 688 of shaft, the second counterbore 690 of shaft 606, or both. In other implementations, two or more coolant flow paths may be present either in parallel or series across the rotor, the stator, the motor, and/or the motor assembly wherein the flow and/or temperature of each coolant flow path may be regulated.

Although this disclosure has provided example implementations in which a rotor is surrounded by a stator, in some implementations an external rotor and internal stator include coolant cans as described throughout this disclosure.

The stator and rotor implementations described throughout this disclosure are examples; in other implementations within the scope of this disclosure, various aspects of the systems for thermal management of an electric motor using coolant cans may be different. For example, a number of windings encapsulated by each coolant can, a number of inlets and/or outlets of each coolant can, a number of teeth included in each of the stator or rotor, and a number of teeth surrounded by each coolant can may be different from the examples shown throughout this disclosure. Shapes of the coolant cans, windings, stator core, and rotor core may be different from the shapes described throughout this disclosure.

In various implementations, coolant cans are comprised of, for example, plastic or another material resistant to corrosion by coolant and capable to withstand the elevated temperatures within the motor. In some implementations, the coolant cans are comprised of a thermally and/or electrically insulating material. In some implementations, the coolant cans are, for example, overmolded or insert-molded. In some implementations, the coolant cans are comprised of metal and/or a composite material. A thickness of one or more walls of the body of the coolant cans may be, in various implementations, at or below 0.15 mm. In other implementations, the thickness of the walls of the body of the coolant cans may be in a range of about 0.15 mm to 0.25 mm. In other implementations, the thickness of the walls of the body of the coolant cans may be in a range of about 0.25 to 0.5 mm. In other implementations, the thickness of the walls of the body of the coolant cans may be in a range of about 0.5 mm to 1.0 mm.

The coolant cans, or components thereof, and/or components of the stator and/or rotors described above may be formed through additive manufacturing techniques, such as by additive manufacturing. To that end, a number of additive manufacturing techniques may be implemented to form the coolant cans, such as vat photopolymerization, material jetting, binder jetting, powder bed fusion, material extrusion, directed energy deposition, and/or sheet lamination. In some embodiments, the coolant cans, or components thereof, may be additively manufactured directly upon a stator and/or a rotor. In some embodiments, a portion of a coolant can may be additively manufactured over a winding disposed in a bottom portion of the coolant can.

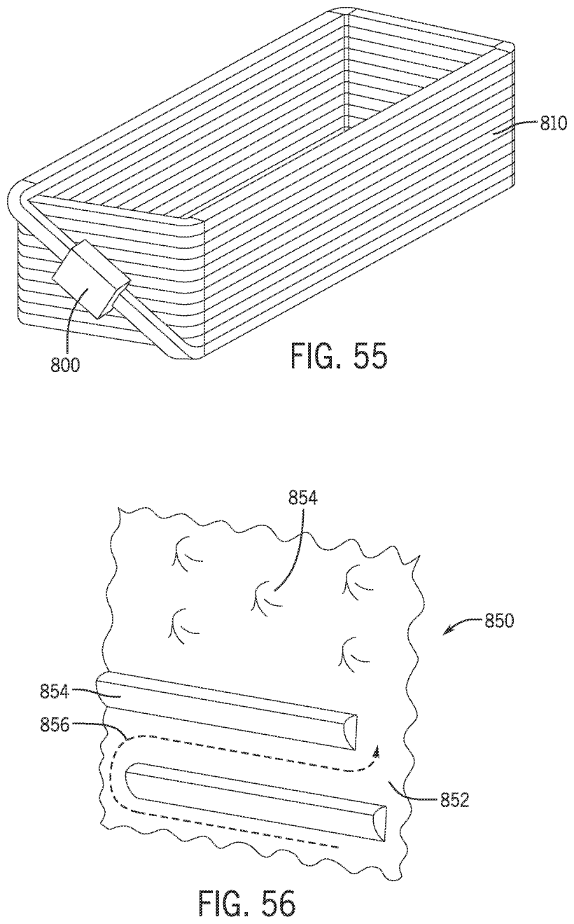

In some implementations, various electrical components may be electrically coupled or connected to one or more windings disposed in the stator, the rotor, the motor, and/or the motor assembly. FIG. 55 shows a discrete circuit component 800 electrically coupled or connected to a winding 810. In some implementations, the discrete circuit component 800 includes one or more sub-components. For example, the discrete circuit component 800 may include an encapsulated integrated circuit or an encapsulated passive or active circuit component. In some implementations, two or more separate windings 810 are coupled together by discrete circuit components 800 included in each of the windings 810.

In some implementations, the discrete circuit component 800 includes a passive circuit component electrically coupled or connected to one or more windings disposed in the stator and/or rotor. In some implementations, the passive circuit component includes a diode or capacitor in certain non-limiting examples. In some implementations, the active circuit component includes one or more transistors. In some implementations, the discrete circuit component 800 includes an integrated circuit electrically coupled or connected to one or more windings disposed in the stator and/or rotor. In some implementations, the integrated circuit includes an active or passive frequency filter.

In some implementations, the discrete circuit component 800 includes a rectifier shorted to at least one winding of the rotor. The rectifier may serve to reduce current ripple in the winding of the rotor by introducing asymmetry into the winding's response to magnetic fields generated by windings of the stator, or to control the current or voltage within an electric machine either in the rotor, the stator, or both. In some implementations, these rectifiers may be included as auxiliary circuits within the electric machine. In some implementations, the rectifier may include a diode, e.g., a p-n junction diode, a gas diode, a Zener, or a Schottky diode. In some implementations, when a Schottky diode is included in the rectifier, the Schottky diode can be a silicon carbide diode. In some implementations, the rectifier includes an active circuit, such as an insulated-gate bipolar transistor (IGBT) or a metal-oxide-semiconductor field-effect transistor (MOSFET). In some implementations, the rectifier comprises an AC/DC rectifier that receives alternating current (AC) power from an AC power source, such as a utility grid or an external generator, and outputs direct current (DC) power to other components of the electric machine and/or to other machines or systems external to the electric machine. For example, the electric machine may be a generator that produces AC power via one or more windings of the generator that include one or more discrete circuit components comprising an AC/DC rectifier, which outputs DC power to an external electric machine, such as a rotor of an electric motor.

In some implementations, the discrete circuit component 800 includes an electrical switch electrically coupled or connected to one or more windings of the stator and/or rotor. The electrical switch may be configured to control electrical current to and/or from the one or more windings 810. In some implementations, the electrical switch includes a busbar in electrical connection to a power source. In some implementations, the electrical switch and busbar are encapsulated in one or more coolant cans with the one or more windings coupled thereto.

In some implementations, the discrete circuit component 800 comprises one or more switches or semiconductor devices coupled to one or more windings and arranged in an electrically conductive network. In such implementations, the plurality of switches or semiconductor devices arranged in an electrically conductive network, which may comprise a plurality of microinverters within a microinverter network, are included as part of an electric machine, for example an electric motor, that are in electrical connection with an electronic motor controller of the electric motor that may regulate the supply of current or voltage to the electric motor.

Current may pass through discrete circuit components 800 as well as through the windings 810 themselves, and thus, the discrete circuit components 800 may heat up during motor operation. Therefore, in some implementations, the discrete circuit components 800 may be encapsulated within one or more coolant cans with the one or more windings 810 coupled thereto, such that coolant contacts the winding and the one or more discrete circuit components 800. In this implementation, the discrete circuit components 800 may be cooled simultaneously with the windings 810. In some implementations, some discrete circuit components 800 and sub-components are encapsulated within the one or more coolant cans with the one or more windings coupled thereto while some discrete circuit components 800 and sub-components are not encapsulated within the coolant can of the one or more windings coupled thereto.

Various implementations of one or more inlets of coolant cans are within the scope of this disclosure. Besides fluidic inlets as described throughout this disclosure, one or more coolant can inlets in some implementations also function as ports for wires or other conductors, e.g., wires providing power to windings or carrying sensor signals. For example, with reference to FIG. 13, three of the four inlet openings 390 on endcap piece 304 may carry wires for respective stator phases of a three-phase motor, and the fourth inlet opening 390 on endcap piece 304 may serve as a coolant inlet. In some implementations, one or more coolant can inlets may be configured to function simultaneously as ports for wires and as a fluidic inlet (see FIGS. 33-41).

In some implementations, the coolant cans may include internal protrusions (e.g., internal walls, bumps, and/or ridges). FIG. 56 shows examples of various protrusions 854 that may be included on an inner surface 852 of an example coolant can 850. In some implementations, the protrusions 854 are configured to apply pressure on one or more windings encapsulated by the coolant can 850, such that the pressure holds the windings in place and increases the mechanical stability of the motor. In some implementations, the protrusions 854 define a labyrinthine shape 856 configured to increase the distance (and thus, time) coolant flows through the coolant can 850 and contacts the one or more windings.

Still referring to FIG. 56, the protrusions 854 may have a variety of shapes and sizes. In some implementations, the protrusions 854 include bumps (e.g., an array of bumps) that enhance turbulence of the coolant flow, which may increase cooling effectiveness. In some implementations, the bumps of the protrusions 854 are configured such that they do not present significant resistance to coolant flow. In some implementations, the protrusions 854 comprising bumps are square shaped rather than round in order to increase turbulence of coolant flowing through the coolant can. In some implementations, the protrusions 854 comprise a plurality of fins arranged parallel to the coolant flow through the coolant can to increase the surface area of the inner surface 852 of the coolant can 850 that flowing coolant contacts while minimizing drag on the coolant flow. In some implementations, the protrusions 854 extend from the inner surface 852 of the coolant can 850 by about 0.25 mm to about 5 mm. In some implementations, instead of, or in addition to, protrusions 854 comprising bumps, the inner surface 852 of the coolant can 850 may include recesses or dimples, for example, dimples extending into the inner surface 852 around the enclosed winding, to induce turbulence of coolant flow through the interior compartment of the coolant can 850.

In some implementations, coolant cans are configured to have a smooth inner or outer surface, depending on whether the particular coolant can is disposed on the stator or rotor, that faces the air gap between the stator and the rotor of the electric motor. For example, as shown in FIGS. 2-12, the bottom wall 246 of the coolant can 204 faces the air gap and may be configured to be flush with a corresponding surface of the stator teeth 214 (see FIG. 12). When the coolant can 204 and the stator tooth 214 are assembled together, the inner surface of the stator 200 formed by the combination of the bottom wall 246 of the coolant can 204 and the bottom surface of the stator tooth can be smooth, thereby reducing, in some implementations, windage losses in the air gap.

In some electrical machines, it may be desirable to provide a system and method for a thermal management system of the electrical machine that is configured to selectively provide cooling to some components of the machine while isolating such cooling from other components of the machine. For example, in conventional electric motor design, the temperature of the stator core and/or the rotor core (in which some windings may be disposed on) is maintained at a lower temperature than the temperature of the windings in order to create an effective thermal gradient for the motor windings. However, as the temperature of the motor core is reduced, the output performance of the electric motor may decrease, which is inverse to the relationship between the temperature of the windings and motor performance, as discussed above. This inverse relationship exists in conventional electric motor design because the stator core and/or the rotor core function similar to a heat sink by removing heat from the windings disposed thereon. Thus, in traditional motor designs, motor performance is typically increased via windings maintaining lower temperatures during motor operation. This is often achieved as a result of heat transferred from the winding to the stator core and/or rotor core directly and/or through the stator core and/or the rotor core to a liquid jacket. Thus, traditional methods of thermal management aim to cool both the core and the windings as discussed herein. However, motor performance can be increased and maintained to the extent that heat in the stator core and/or the rotor core can be maintained, as the core has greater performance at a higher temperature and the gradient is not required to be less than the winding. A undesired effect of conventional electric motor design is that the overall performance of the motor can be increased if the stator core and/or the rotor core is maintained at a temperature that is not dependent on cooling of the windings disposed thereon.

Electric machines having thermal management systems including coolant cans, according to the present disclosure, for example electric motors, do not require the stator core and/or the rotor core to facilitate cooling of the windings disposed thereon, and, therefore, can be operated at higher temperatures. In some implementations, the coolant cans can be configured to facilitate differential thermal management of one or more windings of a stator relative to the stator core of the stator and/or of one or more windings of a rotor relative to the rotor core of the rotor. For example, at the initial start of operation of the electric motor, where both the windings and the stator core and/or rotor core may be at the same relatively low temperature, it may be desirable to improve performance or efficiency of the motor to increase the temperature of the stator core and/or rotor core while cooling the windings disposed thereon.

To continue with this non-limiting example, the coolant cans may be configured to have a coolant flow passage that removes heat from the windings and transfers heat to the stator core and/or rotor core. In such implementations, under steady state continuous operating conditions, the winding temperature is on average equal to the average core temperature for the same operation condition, with stator core and/or rotor core temperature measured by direct thermo-probe and winding temperature measure by electrical resistance, or alternatively as a thermal gradient across the coolant can. In some implementations, a temperature of a winding is on average 5 degrees Celsius less than an average temperature of the stator core and/or rotor core disposed thereon. In some implementations, the temperature of the winding is on average 7.5 degrees Celsius less than the average temperature of the stator core and/or rotor core disposed thereon. In some implementations, the temperature of the winding is on average 10 degrees Celsius less than the average temperature of the stator core and/or rotor core disposed thereon. In some implementations, the temperature of the winding is on average 15 degrees Celsius less than the average temperature of the stator core and/or rotor core disposed thereon. In some implementations, the temperature of the winding is on average 20 degrees Celsius or more less than the average temperature of the stator core and/or rotor core disposed thereon.

For some electrical design and operation purposes it may be beneficial to electrically isolate one or more windings from other components or from the entire system in some electrical machines. For example, in some implementations, the coolant cans can be configured to facilitate electrical isolation of one or more windings from a stator core and/or rotor core. In some implementations, the coolant cans can be configured to be part of an insulator structure of an electric machine, the insulator structure being configured to electrically isolate one or more windings of the electric machine from other components of the machine or from electrical components outside of the machine.

In some implementations, a system for thermal management of an electric machine as described in this disclosure, for example an electric motor having coolant cans, may include temperature control modules that monitor and/or regulate coolant flow and temperature of the electric machine.

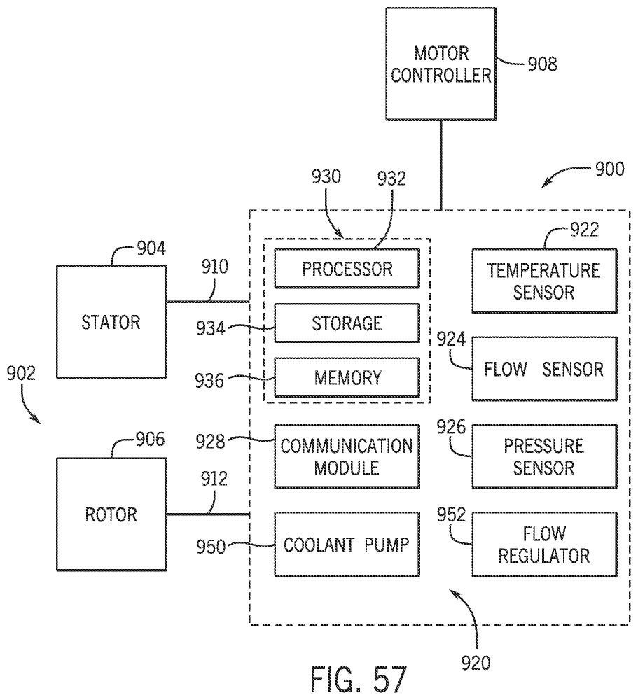

FIG. 57 illustrates a schematic of an example implementation of a temperature control module 900 of an electric motor 902 having a stator 904 and a rotor 906. In some implementations, the temperature control module 900 is electrically coupled to a motor controller 908, which regulates the primary electrical and kinetic operation of the motor 902. In some implementations, the temperature control module 900 is partially or entirely integrated into the motor controller 908.

The temperature control module 900 may be coupled to the stator 904 and/or rotor 906 via couplings 910, 912, respectively. Couplings 910, 912 may be fluidic couplings and/or electrical couplings between the temperature control module 900 and the stator 904 and/or rotor 906, respectively. The stator 904 and the rotor 906 may be any of the stators and rotors described throughout this disclosure or any other stators and rotors not described in this disclosure.

The temperature control module 900 may include various sub-modules 920, each of which may be communicatively coupled to any or all of the other sub-modules 920.

In some implementations, the temperature control module 900 includes one or more temperature sensors 922 that are configured to measure temperatures in the stator 904 or rotor 906. For example, in some implementations, the temperature sensors 922 measure temperatures within one or more coolant cans disposed on the stator 904 and or rotor 906, thus, providing temperature data on windings encapsulated within the coolant cans. In some implementations, temperature sensors 922 measure temperatures of the stator core (e.g., of stator teeth or stator laminations) and/or of the rotor core (e.g., of rotor teeth or rotor laminations). In some implementations, the temperature sensors 922 are in direct fluid communication with the coolant (e.g., positioned inside coolant cans, or positioned on an inlet or outlet flow path to or from the coolant cans). In some implementations, the temperature sensors 922 include one or more of thermocouples, resistive temperature sensors, thermistors, and optical temperature sensors.

In some implementations, the electrical resistance of one or more windings may be measured to infer the future heating load of the rotor or stator on which the winding is mounted. The resistance may be measured by, for example, the motor controller 908, which may send a signal to a controller 930 of the temperature control module 900 to cause the controller 930 to increase or decrease coolant flow in accordance with the measured temperature. Because winding resistance may be a leading indicator of cooling needs (e.g., increased dissipated power in the windings is reflected in a higher winding resistance before coolant temperature would change measurably), this approach may provide more effective and/or more efficient cooling than waiting for a measured temperature to indicate a need to modify coolant flow.

In some implementations, the temperature control module 900 includes one or more flow sensors 924, located, for example, in the coolant cans, and/or in flow paths to and/or from the coolant cans (e.g., in a rotor shaft through which coolant flows). In some implementations, the flow sensors 924 measure a coolant flow rate. In some implementations, the flow sensors 924 measure a volume of coolant (e.g., to determine whether a coolant can is full of coolant).

In some implementations, the temperature control module 900 includes one or more pressure sensors 926 located, for example, in one or more coolant cans, or in flow paths to and/or from one or more coolant cans. The pressure sensors 926 may be configured to measure a fluid pressure of coolant flow for analysis by the temperature control module 900.

In some implementations, the temperature control module 900 and the stator 904 and/or rotor 906 are configured to maintain a positive pressure of coolant inside one or more coolant cans compared to a pressure outside the one or more coolant cans (e.g., compared to a pressure present in the air gap between the stator 904 and rotor 906). The presence of a positive pressure inside one or more coolant cans may reduce coolant backflow in comparison to the presence of an equal or negative pressure inside the one or more coolant cans, and may provide a constant flow of coolant through the one or more coolant cans. In addition, a positive coolant pressure inside one or more coolant cans may maintain full, or substantially full, coolant levels in the one or more coolant cans by reducing interrupted coolant flow inside the coolant cans as the motor operates and thereby increases the mechanical stability of the motor.

Coolant regulation features of the temperature control module 900 may include, in some implementations, one or more coolant pumps 950 and/or one or more flow regulators 952. The coolant pumps 950 are fluidically coupled to one or more inlets of one or more coolant cans (e.g., by tubes and/or pipes). In some implementations, the coolant pumps 950 are fluidically coupled to one or more outlets of one or more coolant cans, and thus, establishing a coolant flow loop. In some implementations, the flow regulators 952 may include, for example, valves, which can modulate flow and/or start or stop coolant flow through the valves. In some implementations, the coolant pump 950 is adjustable, for example, to increase or decrease an output pressure of coolant and/or to increase or decrease a coolant flow rate. In some implementations, separate pumps are used for the stator 904 and the rotor 906. In some implementations, the coolant pumps 950 and/or the flow regulators 952 are configurable by the controller 930 of the temperature control module 900. The controller 930 may include one or more processors 932, one or more storage devices 934, and one or more memory devices 936. In some implementations, the storage devices 934 and/or the memory devices 936 store machine-readable, non-transitory instructions implementing active control by the controller 930.

Flow regulators 952 may be implemented in software to control the flow rate of one or more coolant pumps 950. The control of the flow regulators 952 may be controlled in response to operating conditions in certain implementations, such as the duty cycle or predicted duty cycle of operation. This control may be achieved by a lookup table, multi-input/multi output (MIMO) controller, a plant model such as model predictive control (MPC).

In some implementations, the controller 930 receives a stream of temperature data from the one or more temperature sensors 922 and, in response, sends signals to the coolant pumps 950 and/or the flow regulators 952 to adjust coolant flow. A “stream” of data, as used herein, refers at least to an analog and/or digital electrical interpretable by the controller to indicate a corresponding measurement value and/or configuration.

For example, if a particular temperature sensor 922 indicates that a temperature of one or more windings of the stator 904 is above a threshold value, the controller 930 may send a control signal to a valve in fluid communication with the stator 904 and/or one or more coolant cans disposed on the stator 904 to cause increased coolant flow to the stator 904 (e.g., the control signal may cause the valve to switch to a more open configuration).

In some implementations, the controller 930 receives a stream of coolant flow data from the one or more flow sensors 924 and, in response, sends signals to the coolant pumps 950 and/or the flow regulators 952 to adjust coolant flow. For example, if a particular flow sensor 924 indicates that coolant flow through one or more coolant cans disposed on the rotor 906 is above a threshold value, the controller 930 may send a control signal to a valve to cause decreased coolant flow to the one or more coolant cans of the rotor 906.

In some implementations, the controller 930 receives a stream of coolant pressure data from the one or more pressure sensors 926 and, in response, sends signals to the coolant pumps 950 and/or the flow regulators 952 to adjust coolant pressure. For example, if a particular pressure sensor 926 indicates that a coolant flow passage within one or more coolant cans of the stator 904 is no longer at a positive pressure compared to a pressure within another volume of the motor 902, the controller 930 may send a control signal to a valve to cause increased coolant flow to the one or more coolant cans of the stator 904.

In some implementations, the controller 930 also receives, and send control signals in response to, other data. For example, in some implementations the controller 930 receives signals from the motor controller 908 indicating a change in motor condition (e.g., an imminent increase in speed of the motor 902), to which the controller 930 responds by sending corresponding control signals to match coolant flow conditions to the expected operating condition of the motor 902. This proactive approach may provide more effective and/or more efficient cooling than waiting for a measured temperature to indicate a need for, for example, increased coolant flow.

In some implementations, the motor controller 908 sends a stream to the controller 930 indicating the electrical resistance of one or more windings of the stator 904 and/or rotor 906, or sends a signal to the controller 930 indicating that the electrical resistance of one or more windings of the stator 904 and/or rotor 906 is, for example, above a threshold value. In response, the controller 930 may send signals to the coolant pumps 950 and/or the flow regulators 952 to adjust coolant flow.

Coolant flow control methods are not limited to the foregoing examples that make use of threshold values. In various implementations, coolant flow control methods may include continuous coolant flow response based on continuous input data (e.g., electrical resistance or temperature data). In some implementations, coolant flow control may include using machine learning to predict an anticipated need for coolant flow rate based on motor operation parameters, the machine learning algorithm executed by the one or more processors 932 of the controller 930 of the temperature control module 900 or the motor controller 908.

In some implementations, the temperature control module 900 includes a communication module 928, the communication module 928 configured to, for example, receive signals from and/or transmit signals to any of the sensors described above, the motor controller 908, or another device or signal source. In some implementations, the communication module 928 includes wireless communication devices, such as a near-field communication module, a Bluetooth module, a cellular communication module, and/or a WiFi communication module. In some implementations, the communication module 928 includes hardwired connections to components with which the communication module 928 is communicatively coupled.

In some implementations, the controller 930 of the temperature control module 900 is at least partially mechanical. For example, in some implementations the controller 930 implements coolant flow regulation at least partially by a mechanical response to readings of temperatures, pressures, and/or flow rates, rather than, or in addition to, by the computer processing of machine-readable instructions.

In some implementations, an electric machine as described in this disclosure, for example an electric motor having coolant cans, may include one or more coolant manifolds configured to regulate coolant flow within the electric machine.

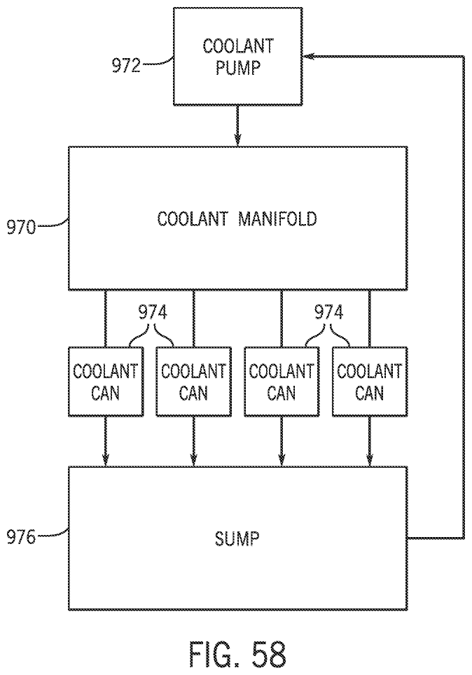

FIG. 58 illustrates a schematic of an example implementation of an enclosed coolant manifold 970 that is configured to receive flow of coolant from a coolant pump 972. The coolant manifold 970 is fluidically coupled (e.g., by pipes or tubes) to one or more inlets of one or more coolant cans 974. From one or more outlets of the one or more coolant cans 974, coolant is directed to a sump 976. The coolant pump 972 is configured to draw coolant from the sump 976, and thus, completing a flow loop of coolant.

In some implementations, the coolant pump 972 may be the one or more coolant pumps 950 that are configurable by the controller 930 of the temperature control module 900, as discussed above (see FIG. 57). In some implementations, the coolant manifold 970 may be the one or more flow regulators 952 that are configurable by the controller 930 of the temperature control module 900, as discussed above (see FIG. 57).

In some implementations, the outlets of coolant cans disposed on the stator and/or the rotor may be configured to provide directed cooling to other components of the electric motor. For example, in some implementations, coolant cans are configured such that coolant, after flowing through the coolant cans of the stator and/or the rotor, enters the working volume of the electric motor (e.g., by outlets that drain directly into the working volume of the motor). In some implementations, the outlets of the coolant cans are positioned such that coolant flowing out of the coolant cans of the stator and/or the rotor enters a portion of the working volume in which the coolant will cause relatively few windage losses, such as a sump port positioned at the gravitational bottom of the motor and in fluidic communication with the working volume (see FIG. 58). Fluid levels in the sump are regulated such that coolant in the sump does not reach the gravitationally lowest position of the air gap. In such implementations, the sump may be in fluid communication with one or more fluid pump (as shown in FIG. 58).

In addition, in some implementations, outlets of the coolant cans are configured to direct coolant from the coolant cans to particular components of the motor, e.g., other components that increase in temperature during motor operation and may be desirable to cool. For example, in some implementations the coolant is directed out of the coolant can outlets to contact bearings of the motor, thereby cooling the bearings.

In some implementations, outlets of coolant cans disposed on the rotor may be configured to provide spray cooling to the stator windings. In some implementations, outlets of coolant cans disposed on the stator may be configured to provide spray cooling to the rotor windings. For example, with reference to FIGS. 42-53, peripheral outlets may be included on the top wall 644 near the inlet and outlet 656, 658 of the coolant can 612, such that, as the coolant cans 612 rotate, a volume of coolant flows out of the coolant cans 612 through the peripheral outlets and contacts a stator (not shown) surrounding the rotor 600. This implementation may provide spray cooling to stator windings, which may not be enclosed within coolant cans of the stator. Conversely, in some implementations, with particular reference to FIGS. 2-12, axially facing additional outlets may be included on the bottom wall 246 of coolant can 204 of the stator 200, such that a volume of coolant flows out of the coolants cans 204 through the axially facing additional outlets into the air gap of the motor, thereby providing spray cooling to the rotor.

The various implementations described throughout this disclosure refer to flow of a coolant within an electric machine; in other implementations within the scope of this disclosure, various aspects of the coolant may be different. In some implementations, the liquid coolant comprises a mix of a coolant and a lubricant, configured to provide sufficient cooling to one or more windings encapsulated within one or more coolant cans while providing cooling and lubrication to other components of the electric machine outside of the coolant cans. In some implementations, the coolant is a gas configured to provide gaseous cooling to the one or more windings encapsulated within one or more coolant cans. In some implementations, one or more coolant cans includes two or more interior compartments that are fluidically isolated from each other and each having an inlet and an outlet, such that one interior compartment encapsulates one or more windings with an inlet configured to receive coolant while the inlet of one or more other interior compartments are configured to receive a flow of lubricant through the interior compartment to one or more outlets, which may be directed to other components of the electric machine. In such implementations, the thermal management system of the electric machine may include two or more separate fluid pumps, at least one configured to pump coolant and one configured to pump lubricant. In such implementations, the thermal management system may include a single fluid manifold in fluid connection with the two or more separate fluid pumps, such that the coolant and the lubricant pumped to the manifold are mixed in the manifold and while flowing to the one or more coolant cans.

Although some of the discussion above is framed in particular around thermal management systems, such as the various electric machines having thermal management systems including coolant cans, those of skill in the art will recognize therein an inherent disclosure of corresponding methods of use (or operation) of the disclosed systems, and the methods of installing the disclosed systems. Correspondingly, some non-limiting examples of the disclosure can include methods of using, making, and installing electric machines having thermal management systems including coolant cans.

Although some of the discussion above is framed in particular around systems, such as the various electric machines including winding coolant cans, those of skill in the art will recognize therein an inherent disclosure of corresponding methods of use (or operation) of the disclosed systems, and the methods of installing the disclosed systems. Correspondingly, some non-limiting examples of the disclosure can include methods of using, making, and installing electric machines including winding coolant cans.

For example, some implementations can include a method for thermal management of an electric machine having a thermal management system by flowing a coolant through an interior compartment of one or more coolant cans that encapsulate one or more windings or conductive elements of the electric machine within the interior compartment of the coolant can that is fluidically isolated from other components of the electric machine, such that the one or more windings have a lower temperature than other components of the electric machine. In an example implementation, with reference to FIGS. 57 and 58, the temperature control module 900 causes the coolant pump 950 (or coolant pump 972 in FIG. 58) and/or flow regulator 952 to pump coolant to flow through one or more coolant cans 974, such that the one or more windings encapsulated within the one or more coolant cans 974 have a lower temperature than other components of the stator 904 and/or the rotor 906. In some implementations, the coolant pump 972 pumps coolant to the coolant manifold 970 and to one or more coolant cans 974 in fluid communication with the coolant manifold 970.

In some implementations, the method can further include detecting a temperature of the one or more windings encapsulated within the one or more coolant cans and determining whether the detected temperature is above a threshold value. Then flowing additional coolant through the interior compartment of the one or more coolant cans in response to determining that the detected temperature is above the predetermined threshold value. In an example implementation, with reference to FIGS. 57 and 58, the controller 930 of the temperature control module 900 receives, stores, and processes inputs from the one or more temperature sensors 922 and causes the pump 950 (or coolant pump 972 in FIG. 58) and/or flow regulator 952 to pump additional coolant to flow through the one or more coolant cans 974 that are determined to have temperatures above the predetermined threshold value. It should be understood that it is contemplated that the method described above can also be applied to a detected electrical resistance of the one or more windings and predetermined threshold values of an electrical resistance.

In some implementations, the method can further include detecting a pressure within the one or more coolant cans and the working volume of the electric machine. Determining whether the detected pressure within the one or more coolant cans is below the detected pressure within the working volume of the electric machine. Then applying a positive pressure, by a pump, within one or more of the coolant cans compared to the detected pressure of the working volume of the electric machine. In an example implementation, with reference to FIGS. 57 and 58, the controller 930 of the temperature control module 900 receives, stores, and processes inputs from the one or more pressure sensors 926 and causes the pump 950 (or coolant pump 972 in FIG. 58) and/or flow regulator 952 to pump additional coolant to flow through the one or more coolant cans 974, i.e. applying increased flow pressure, that are determined to have pressures lower than the detected pressure of the working volume of the electric motor 902, such as in the air gap between the stator 904 and the rotor 906.

Although the invention has been described and illustrated in the foregoing illustrative non-limiting examples, it is understood that the present disclosure has been made only by way of example, and that numerous changes in the details of implementation of the invention can be made without departing from the spirit and scope of the invention, which is limited only by the claims that follow. Features of the disclosed non-limiting examples can be combined and rearranged in various ways.

Furthermore, the non-limiting examples of the disclosure provided herein are not limited in application to the details of construction and the arrangement of components set forth in the following description or illustrated in the following drawings. The invention is capable of other non-limiting examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, the use the phraseology and terminology used herein is for the purpose of description and should not be regarded as limiting. The use of “right”, “left”, “front”, “back”, “upper”, “lower”, “above”, “below”, “top”, or “bottom” and variations thereof herein is for the purpose of description and should not be regarded as limiting. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Unless otherwise specified or limited, phrases similar to “at least one of A, B, and C,” “one or more of A, B, and C,” etc., are meant to indicate A, or B, or C, or any combination of A, B, and/or C, including combinations with multiple or single instances of A, B, and/or C.

In some non-limiting examples, aspects of the present disclosure, including computerized implementations of methods, can be implemented as a system, method, apparatus, or article of manufacture using standard programming or engineering techniques to produce software, firmware, hardware, or any combination thereof to control a processor device, a computer (e.g., a processor device operatively coupled to a memory), or another electronically operated controller to implement aspects detailed herein. Accordingly, for example, non-limiting examples of the invention can be implemented as a set of instructions, tangibly embodied on a non-transitory computer-readable media, such that a processor device can implement the instructions based upon reading the instructions from the computer-readable media. Some non-limiting examples of the invention can include (or utilize) a device such as an automation device, a special purpose or general purpose computer including various computer hardware, software, firmware, and so on, consistent with the discussion below.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize many modifications may be made to these configurations without departing from the scope or spirit of the claimed subject matter.

Certain operations of methods according to the invention, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular non-limiting examples of the invention. Further, in some non-limiting examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As used herein, the term, “controller” and “processor” and “computer” include any device capable of executing a computer program, or any device that includes logic gates configured to execute the described functionality. For example, this may include a processor, a microcontroller, a field-programmable gate array, a programmable logic controller, etc. As another example, these terms may include one or more processors and memories and/or one or more programmable hardware elements, such as any of types of processors, CPUs, microcontrollers, digital signal processors, or other devices capable of executing software instructions.

1. An electric machine having a thermal management system, the electric machine comprising:
a stator including a stator core;
a rotor including a rotor core, the rotor being movable with respect to the stator,
wherein one or more windings are included in at least one of the stator or the rotor of the electric machine,
wherein one or more coolant cans encapsulate the one or more windings of the at least one of the stator or the rotor in an interior compartment of the coolant can, the interior compartment defining a coolant flow passage through the one or more windings, the coolant can having a coolant inlet and a coolant outlet in fluid connection with the interior compartment, and
wherein the interior compartment of the one or more coolant cans are fluidically isolated from the stator core and the rotor core.

2. The electric machine of claim 1, wherein the interior compartment of one or more coolant cans are fluidically isolated from the interior compartments of one or more other coolant cans.

3. The electric machine of claim 1, wherein the one or more windings comprise concentrated windings.

4. The electric machine of claim 3, wherein the coolant can includes an interior wall extending through the interior compartment that defines an opening through the coolant can, and
wherein the concentrated winding is wound around the interior wall within the interior compartment.

5. The electric machine of claim 4, wherein the opening of the coolant can is configured to be received by one or more teeth of a plurality of teeth included on the stator core.

6. The electric machine of claim 4, wherein the opening of the coolant can is configured to be received by one or more poles of the rotor core.

7. The electric machine of claim 1, wherein the winding is a distributed winding disposed in the stator,
wherein the stator includes a coolant can frame that defines two or more coolant cans having their inlets and outlets in fluid communication with each other,
wherein the stator core includes a plurality of teeth, the stator core being disposed on the coolant can frame such that a tooth of the stator core is disposed between the two or more coolant cans, and
wherein the distributed winding is disposed within the two or more coolant cans having inlets and outlets in fluid communication with each other.

8. The electric machine of claim 7, wherein the coolant can frame includes a first endcap disposed at a first axial end of the stator and a second endcap, opposite the first endcap,
wherein the first endcap defines an interior compartment having an inlet and the second endcap defines an interior compartment having an outlet,
wherein the inlets of the two or more coolant cans having inlets in fluid communication with each other are in fluid communication with the interior compartment of the first endcap, and
wherein the outlets of the two or more coolant cans having outlets in fluid communication with each other are in fluid communication with the interior compartment of the second endcap.

9. The electric machine of claim 5, wherein the one or more concentrated windings are toroidal shaped.

10. The electric machine of claim 9, wherein the stator core is comprised of a plurality of stator segments,
wherein one or more teeth of the plurality of teeth of the stator core is included on the stator segment, and
wherein the opening of the coolant can is received by the one or more teeth of the stator segment.

11. The electric machine of claim 6, wherein the rotor includes a shaft that defines a coolant inlet and a coolant outlet, the coolant inlet of the shaft being in fluid communication with the coolant inlets of the coolant cans and the coolant outlet of the shaft being in fluid communication with the coolant outlet of the coolant cans, and
wherein, while the rotor rotates, coolant flowing into the coolant inlet of the shaft flows through the coolant cans to the coolant outlet of the shaft.

12. The electric machine of claim 11, wherein the shaft defines an interior compartment extending through a longitudinal axis of the shaft,
wherein, while the rotor rotates, a first portion of a volume of coolant flowing into the coolant inlet of the shaft flows through the coolant cans to the coolant outlet of the shaft, and a second portion of the volume of coolant flowing into the coolant inlet of the shaft flows through the interior compartment of the shaft to the coolant outlet of the shaft.

13. The electric machine of claim 12, wherein one or more electrical components of the electric machine is disposed within the interior compartment of the shaft.

14. The electric machine of claim 1, wherein one or more coolant cans has a plurality of outlets, and
wherein at least one of the plurality of outlets are directed to a working volume of the electric machine including the stator and the rotor.

15. The electric machine of claim 1, wherein an electrical component of the electric machine is disposed within the interior compartment with the one or more windings in the coolant can.

16. An electric machine having a thermal management system, the electric machine comprising:
a stator including a stator core;
a rotor including a rotor core, the rotor being movable with respect to the stator;
a coolant pump; and
a controller in electrical connection with the coolant pump, the controller being configured to control the coolant pump,
wherein one or more windings are included in at least one of the stator or the rotor of the electric machine,
wherein one or more coolant cans encapsulate one or more of the windings disposed on the at least one of the stator or the rotor in an interior compartment of the coolant can, the interior compartment defining a coolant flow passage through the one or more windings, the coolant can having a coolant inlet and a coolant outlet in fluid connection with the interior compartment, and
wherein the coolant pump is in fluid communication with one or more coolant inlets of the one or more coolant cans.

17. The electric machine of claim 16, wherein a sensor is disposed within the interior compartment of one or more coolant cans with the one or more windings, the sensor being in electrical connection with the controller, such that the controller receives outputs from the sensor.

18. The electric machine of claim 17, wherein the controller includes a processor, a storage, and a memory, the processor being configured to process inputs received from the sensor that are stored in the storage and predetermined threshold values stored in the memory, and
wherein the controller is configured to adjust an output of the coolant pump.

19. The electric machine of claim 18, wherein the sensor is configured to detect a temperature of coolant flowing through the one or more coolant cans encapsulating the one or more windings disposed on at least one of the stator and the rotor, and
wherein the predetermined threshold values stored in the memory of the controller are configured such that, under steady-state continuous operating conditions, the temperature of the coolant flowing through the one or more coolant cans encapsulating the one or more windings disposed on at least one of the stator and the rotor is at least 5 degrees Celsius less than a temperature of the stator core or rotor core disposed thereon.

20. The electric machine of claim 19, wherein the stator core is comprised of a plurality of laminations, and
wherein the predetermined threshold values stored in the memory of the controller are configured such that, under steady-state continuous operating conditions, the temperature of the coolant flowing through the one or more coolant cans encapsulating the one or more windings disposed on the stator is at least 5 degrees Celsius less than an average temperature of the laminations of the stator core disposed thereon.

21. The electric machine of claim 19, wherein the rotor is comprised of a plurality of laminations, and
wherein the predetermined threshold values stored in the memory of the controller are configured such that, under steady-state continuous operating conditions, the temperature of the coolant flowing through the one or more coolant cans encapsulating the one or more windings disposed on the rotor is at least 5 degrees Celsius less than an average temperature of the laminations of the rotor core disposed thereon.

22. A method for thermal management of an electric machine having a thermal management system, the method comprising:
flowing a coolant through an interior compartment of one or more coolant cans that encapsulate one or more windings of the electric machine within the interior compartment of the coolant can, the interior compartment of the coolant can being fluidically isolated from other components of the electric machine.

23. The method of claim 22 further comprising:
detecting a temperature of the one or more windings encapsulated within the one or more coolant cans;
determining that the detected temperature is above a threshold value; and
in response to determining that the detected temperature is above the threshold value, flowing additional coolant through the interior compartment of the one or more coolant cans.
